(19) United States
(12) Patent Application Publication
(10) Pub. No.: US 2022/0281119 A1
(43) Pub. Date: Sep. 8, 2022

(54) ROBOT SYSTEM, AND METHOD FOR MANUFACTURING PRODUCT

(71) Applicant: CANON KABUSHIKI KAISHA, Tokyo (JP)

(72) Inventor: Haruhiko Horiguchi, Tokyo (JP)

(21) Appl. No.: 17/669,596

(22) Filed: Feb. 11, 2022

(30) Foreign Application Priority Data
Mar. 2, 2021 (JP) 2021-032211

(51) Int. Cl. B25J 13/08; B25J 9/16; B25J 9/10

(52) U.S. Cl. CPC B25J 13/085; B25J 13/088; B25J 9/1633; B25J 9/1687; B25J 9/102

(57) ABSTRACT

A robot system includes a robot including a reduction gear and an encoder, and a processing portion configured to obtain a torque value by using phase information based on a detection signal of the encoder. The encoder includes a scale including a pattern portion, and a head configured to read the pattern portion of the scale and output the detection signal. The processing portion is configured to obtain a first displacement amount of the scale in a first direction that is a relative direction with respect to the head. The processing portion is configured to obtain a second displacement amount of the scale in a second direction that is a relative direction with respect to the head and intersecting with the first direction. The processing portion is configured to obtain the torque value on a basis of the first displacement amount and the second displacement amount.

### BACKGROUND OF THE INVENTION

### Field of the Invention

The present invention relates to sensing technology.

### Description of the Related Art

In a manufacture line in a factory or the like, an industrial robot is installed for improving the productivity of a product to be manufactured. Examples of the industrial robot include a cooperative robot capable of cooperating with an operator. Japanese Patent Laid-Open No. 2020-104249 discloses an industrial robot including a torque sensor for detecting contact with the operator or an object.

The torque sensor includes a displacement detection device such as an encoder device, and obtains a torque value by using displacement information detected by the displacement detection device. In recent years, driving devices such as robots have come to be required of precise operation, and therefore torque sensors, that is, displacement detection devices have come to be required of high detection precision.

### SUMMARY OF THE INVENTION

According to a first aspect of the present invention, a robot system includes a robot including, in a joint thereof, a reduction gear and at least one encoder, and a processing portion configured to obtain a torque value by using phase information based on a detection signal of the encoder. The encoder includes a scale including a pattern portion, and a head disposed to oppose the scale and configured to read the pattern portion of the scale and output the detection signal. The processing portion is configured to obtain, on a basis of the phase information, a first displacement amount of the scale in a first direction and a second displacement amount of the scale in a second direction. The first direction is a relative direction with respect to the head. The second direction is a relative direction with respect to the head and intersecting with the first direction. The processing portion is configured to obtain the torque value on a basis of the first displacement amount and the second displacement amount.

According to a second aspect of the present invention, a robot system includes a robot including, in a joint thereof, a reduction gear and at least one encoder, a processing portion configured to obtain a torque value by using phase information based on a detection signal of the encoder, and a storage portion configured to store a correction value associated with trajectory data of the robot. The encoder includes a scale including a pattern portion, and a head disposed to oppose the scale and configured to read the pattern portion of the scale and output the detection signal. The processing portion is configured to obtain, on a basis of the phase information obtained while the robot is operating in accordance with the trajectory data, a first displacement amount of the scale in a first direction that is a relative direction with respect to the head, and obtain the torque value on a basis of displacement information obtained by correcting the first displacement amount by using the correction value corresponding to the trajectory data.

Further features of the present invention will become apparent from the following description of exemplary embodiments with reference to the attached drawings.

### BRIEF DESCRIPTION OF THE DRAWINGS

FIG. 1 is an explanatory diagram of a robot system according to a first embodiment.

FIG. 2 is a partial section view of the robot system illustrating a joint of a robot arm according to the first embodiment.

FIG. 3 is a block diagram illustrating a control system of the joint of the robot arm according to the first embodiment.

FIG. 4 is a perspective view of a torque sensor according to the first embodiment.

FIG. 5A is a block diagram illustrating a configuration of the torque sensor according to the first embodiment.

FIG. 5B is a block diagram illustrating functions of the torque sensor according to the first embodiment.

FIG. 6A is a schematic view of an encoder device serving as an example of a displacement detection device according to the first embodiment.

FIG. 6B is a plan view of a sensor head according to the first embodiment.

FIG. 7A is an explanatory diagram of the torque sensor according to the first embodiment.

FIG. 7B is an explanatory diagram of the torque sensor according to the first embodiment.

FIG. 8 is an explanatory diagram of a scale according to the first embodiment.

FIG. 9 is a plan view of a light receiving element array according to the first embodiment.

FIG. 10 is a circuit diagram of a circuit portion of a signal processing circuit according to the first embodiment.

FIG. 11A is a flowchart illustrating an example of a robot control method according to the first embodiment.

FIG. 11B is a flowchart illustrating an example of a torque detection method according to the first embodiment.

FIG. 12 is a graph illustrating a relationship between a phase and a scale position according to the first embodiment.

FIG. 13A is an explanatory diagram of a principle of the first embodiment.

FIG. 13B is an explanatory diagram of the principle of the first embodiment.

FIG. 13C is a schematic view of a Lissajous waveform according to the first embodiment.

FIG. 14 is a graph illustrating a relationship between a difference and a displacement amount according to the first embodiment.

FIG. 15 is a plan view of a scale of a modification example.

FIG. 16A is a schematic view of an encoder device serving as an example of a displacement detection device according to a second embodiment.

FIG. 16B is a plan view of a sensor head according to the second embodiment.

FIG. 17 is an explanatory diagram of a scale according to the second embodiment.

FIG. 18 is a plan view of a light receiving element array according to the second embodiment.

FIG. 19 is a plan view of the light receiving element array according to the second embodiment.

FIG. 20A is a schematic view of an encoder device serving as an example of a displacement detection device according to a third embodiment.

FIG. 20B is a plan view of a sensor head according to the third embodiment.

FIG. 21 is an explanatory diagram of a scale according to the third embodiment.

FIG. 22A is a flowchart illustrating pre-processing in a robot system according to a third embodiment.

FIG. 22B is a flowchart illustrating an example of a torque detection method according to the third embodiment.

### DESCRIPTION OF THE EMBODIMENTS

Embodiments of the present invention will be described in detail below with reference to drawings.

### First Embodiment

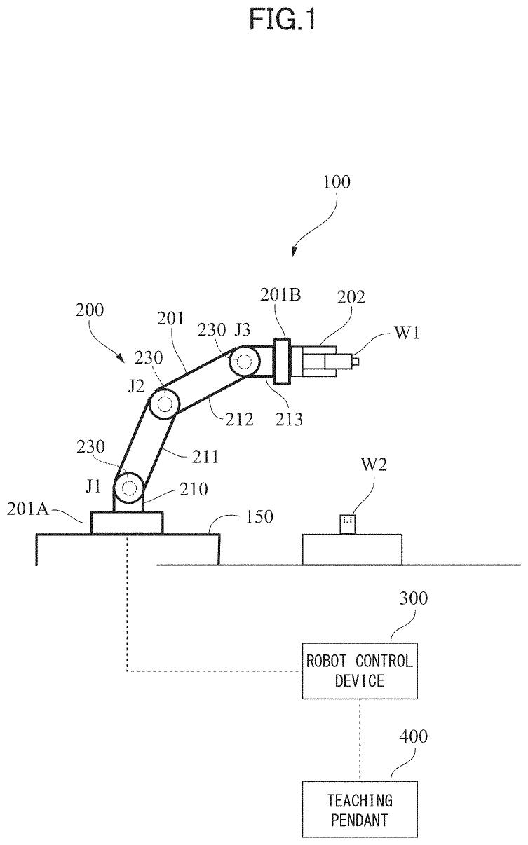

FIG. 1 is an explanatory diagram of a robot system 100 according to a first embodiment. As illustrated in FIG. 1, the robot system 100 includes a robot 200 and a robot control device 300. The robot 200 is an industrial robot, and is used for manufacturing a product. The robot 200 is capable of performing an operation for manufacturing a product, for example, an operation of gripping a first workpiece W1 and mounting the gripped first workpiece W1 on a second workpiece W2.

The robot control device 300 serves as an example of a control portion, and controls the robot 200. A teaching pendant 400 serving as an example of a teaching device can be connected to the robot control device 300. The teaching pendant 400 is a device for performing teaching on the robot 200, and outputs teaching data to the robot control device 300. The robot control device 300 generates trajectory data on the basis of the teaching data, and operates the robot 200 in accordance with the trajectory data.

The robot 200 includes a robot arm 201, and a robot hand 202 serving as an example of an end effector. The robot arm 201 is, for example, a vertically articulated robot arm. A fixed end 201A that is a proximal end of the robot arm 201 is fixed to a stand 150. The robot hand 202 is attached to a free end 201B that is a distal end of the robot arm 201. The robot arm 201 includes a plurality of links 210, 211, 212, and 213, and the links 210 to 213 are rotatably interconnected by joints J1, J2, and J3. The joints J1 to J3 of the robot arm 201 are each provided with a driving device 230. As the driving device 230 of each of the joints J1 to J3, a driving device of an appropriate output matching a required torque is used.

In the robot arm 201, the joint J1 will be described as an example, and description of the other joints J2 and J3 will be omitted because these have a similar configuration to the joint J1 although the size and performance thereof may be different.

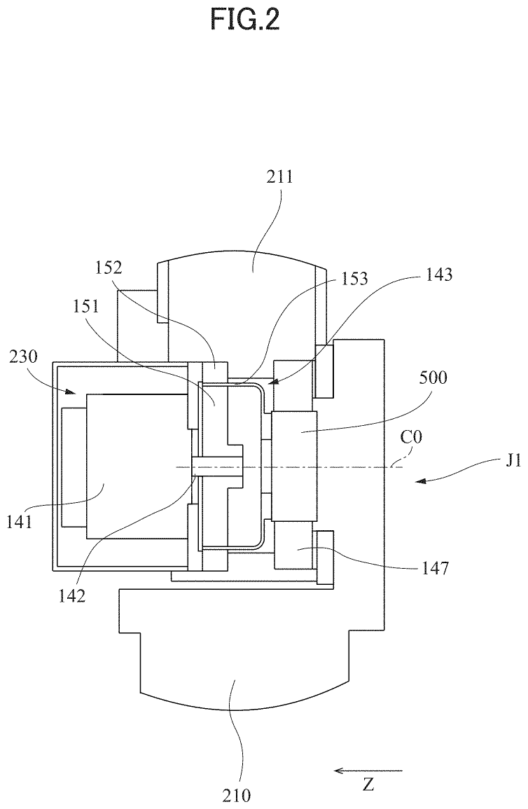

FIG. 2 is a partial section view of the robot arm 201 according to the first embodiment illustrating the joint J1. The driving device 230 includes an electric motor 141 serving as a rotation drive source, a reduction gear 143 that is coupled to a rotation shaft portion 142 of the motor 141 and outputs reduced rotation of the rotation shaft portion 142, and a torque sensor 500. The rotation shaft portion 142 of the motor 141 rotates about a rotation axis C0. The links 210 and 211 are rotatably coupled to each other via a cross-roller bearing 147. The motor 141 is a servo motor, for example, a brushless DC servo motor or an AC servo motor. The reduction gear 143 is a strain wave reduction gear in the first embodiment. The reduction gear 143 includes a wave generator 151 that is coupled to the rotation shaft portion 142 of the motor 141 and serves as an example of an input shaft, and a circular spline 152 that is fixed to the link 211 and serves as an example of an output shaft. To be noted, although the circular spline 152 is coupled to the link 211, the circular spline 152 may be integrally formed with the link 211. In addition, the reduction gear 143 includes a flex spline 153 disposed between the wave generator 151 and the circular spline 152 and coupled to the link 210 via the torque sensor 500. The flex spline 153 is formed in a cup shape. The flex spline 153 is warped into an elliptical shape by the wave generator 151, and engages with the circular spline 152 at a long axis portion of the elliptical shape thereof. When the wave generator 151 rotates, the long axis portion of the elliptical shape of the flex spline 153 rotates, and the engagement position between the flex spline 153 and the circular spline 152 moves in the rotation direction of the wave generator 151. Each time the wave generator 151 rotates once, the circular spline 152 relatively rotates with respect to the flex spline 153 by an amount corresponding to the difference in the number of teeth between the flex spline 153 and the circular spline 152. As a result, the speed of the circular spline 152 is reduced with respect to the rotation of the wave generator 151 at a predetermined reduction ratio, and relatively rotates with respect to the flex spline 153. Therefore, the link 211 coupled to the circular spline 152 relatively rotates about the rotation axis C0 with respect to the link 210 coupled to the flex spline 153 via the torque sensor 500.

The torque sensor 500 is disposed on the flex spline 153 that is on the output side of the reduction gear 143. That is, the torque sensor 500 is disposed between the link 210 and the flex spline 153 of the reduction gear 143, that is, between the link 210 serving as an example of a first link and the link 211 serving as an example of a second link. Further, the torque sensor 500 measures a torque about the rotation axis C0 acting between the link 210 and the link 211, and outputs an electric signal corresponding to a torque value serving as a measurement value to the robot control device 300. The electric signal is a digital signal. The robot control device 300 controls the robot 200 on the basis of the torque value.

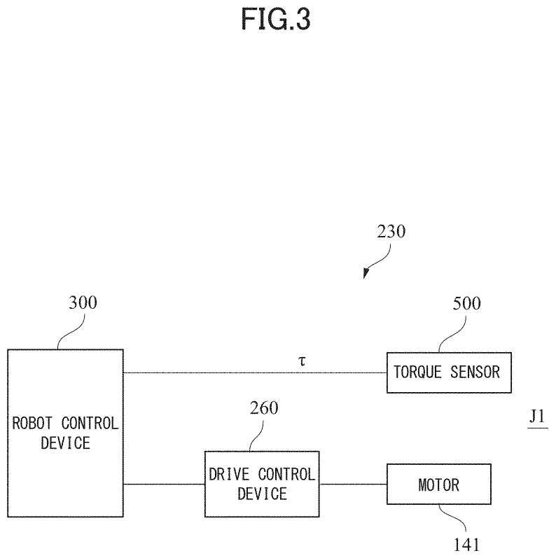

FIG. 3 is a block diagram illustrating a control system of the joint J1 of the robot arm 201 according to the first embodiment. The driving device 230 includes a drive control device 260 electrically connected to the motor 141 and the robot control device 300. The torque sensor 500 of the driving device 230 is electrically connected to the robot control device 300.

The robot control device 300 integrally controls the whole robot system. That is, the robot control device 300 controls the operation of the robot 200. Control of the operation of the robot 200 includes position control and force control. In position control, the robot control device 300 generates an operation command on the basis of the position of the tip of the hand of the robot 200, and outputs the generated operation command to the drive control device 260. In the force control, the robot control device 300 generates an operation command on the basis of the torque value that is a measurement value received from the torque sensor 500, and outputs the generated operation command to the drive control device 260. The drive control device 260 performs power supply control of the motor 141 in accordance with the operation command, and thus drives the motor 141. In force control, the robot control device 300 operates the robot 200 on the basis of the torque value output from the torque sensor 500. Therefore, the performance of the force control of the robot 200 depends on the precision, that is, the resolution of the torque sensor 500.

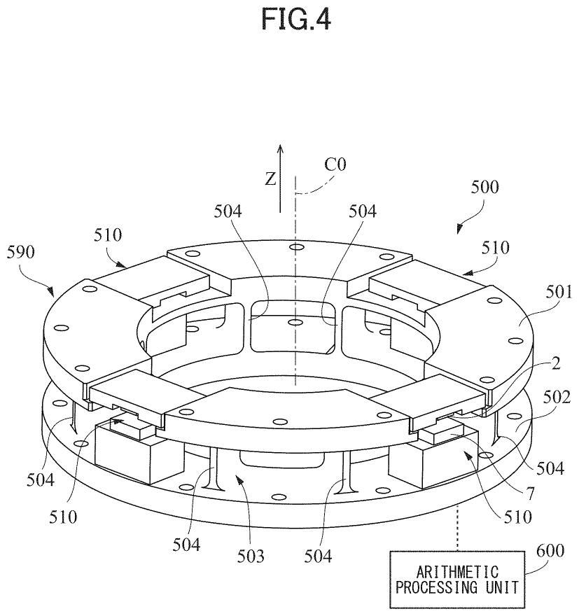

FIG. 4 is a perspective view of the torque sensor 500 according to the first embodiment. The torque sensor 500 includes a sensor body 590 and an arithmetic processing unit 600. The sensor body 590 includes a support portion 501 serving as an example of a first member fastened and thus fixed to the reduction gear 143 illustrated in FIG. 2, and a support portion 502 serving as an example of a second member fastened and thus fixed to the link 210 illustrated in FIG. 2.

The support portions 501 and 502 are each a member having a flat plate shape, and has, for example, an annular shape centered on the rotation axis C0 as illustrated in FIG. 4. The support portion 502 is relatively displaceable with respect to the support portion 501 in a rotation direction centered on the rotation axis C0. To be noted, the shape of each of the support portions 501 and 502 is not limited to this, and may be, for example, a disk shape. The support portions 501 and 502 constitute flange portions so as to be respectively fastenable to the reduction gear 143 and the link 210 by bolts or the like. The support portions 501 and 502 are disposed at an interval in the Z direction, which is a direction in which the rotation axis C0 extends, so as to oppose each other, and are coupled to each other via an elastic portion 503.

The elastic portion 503 includes a plurality of leaf springs 504 arranged radially at intervals around the rotation axis C0. When a torque acts between the links 210 and 211 illustrated in FIG. 2, the support portion 502 is relatively rotationally displaced about the rotation axis C0 with respect to the support portion 501 by a rotation amount corresponding to the magnitude of the acting torque. The leaf springs 504 are each formed from a material having an elastic modulus, that is, a spring modulus corresponding to the measurement range of a target torque and required resolution. The material of the elastic portion 503 is, for example, resin or metal, and is preferably metal. Examples of the metal include steel and stainless steel. In the first embodiment, the support portion 501, the support portion 502, and the elastic portion 503 are all formed from the same material, and are integrally formed. The support portion 501, the support portion 502, and the elastic portion 503 do not have to be formed integrally.

The sensor body 590 includes at least one encoder used for measuring relative displacement between the support portions 501 and 502, that is, a torque acting between the support portions 501 and 502. The at least one encoder is preferably a plurality of encoders. The plurality of encoders are preferably four encoders 510. That is, in the first embodiment, the sensor body 590 includes four encoders 510. The four encoders 510 all have the same configuration. The four encoders 510 are arranged at positions with 90-degree symmetry about the rotation axis C0 at equal intervals. To be noted, although the number of the encoders 510 included in the sensor body 590 is preferably 4, the configuration is not limited to this. The number of encoders 510 included in the sensor body 590 may be, 1, 2, 3, 5, or more. The encoders 510 are each an incremental encoder. Although an incremental encoder will be described as an example in the present embodiment, the encoder may be of an absolute type. In addition, the encoders 510 are each preferably an optical encoder, an electrostatic capacitance encoder, or a magnetic encoder. Among these, an optical encoder is more preferable because higher detection resolution can be realized. Therefore, in the first embodiment, the encoders 510 are each an optical encoder.

The encoders 510 each may be a linear encoder or a rotary encoder. The relative displacement between the support portions 501 and 502 in the rotation direction about the rotation axis C0 is minute and can be regarded as displacement in a translational direction at the position of each encoder 510. Therefore, in the first embodiment, the encoders 510 are each a linear encoder. The encoders 510 are each capable of detecting relative displacement between the support portions 501 and 502 in the rotation direction about the rotation axis C0, that is, in the tangential direction.

The encoders 510 each include a scale 2, and a sensor head 7 serving as an example of a head disposed to oppose the scale 2. The sensor head 7 is a sensor unit. The scale 2 is fixed to and thus supported by one of the support portions 501 and 502. In the first embodiment, the scale 2 is fixed to and supported by the support portion 501. The sensor head 7 is fixed to and thus supported by the other of the support portions 501 and 502. In the first embodiment, the sensor head 7 is fixed to and thus supported by the support portion 502. To be noted, the scale 2 may be supported by the support portion 502, and the sensor head 7 may be supported by the support portion 501. By using the encoders 510, the relative displacement between the support portions 501 and 502 can be measured as a relative amount with respect to a certain standard position.

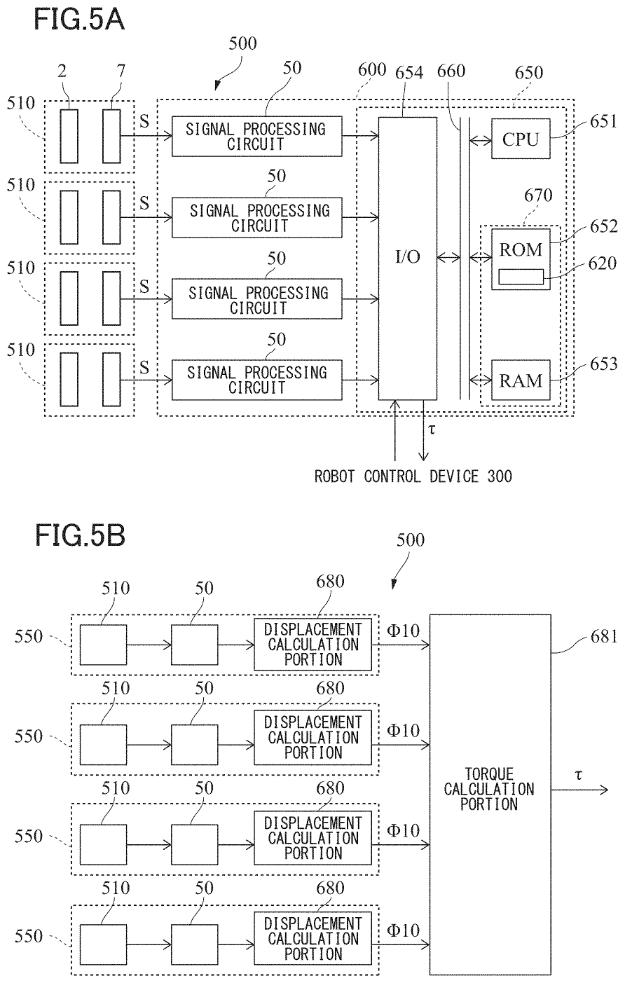

FIG. 5A is a block diagram illustrating a configuration of the torque sensor 500 according to the first embodiment. The arithmetic processing unit 600 includes signal processing circuits 50 of the same number as the encoders 510, for example, four signal processing circuits 50, and a computer 650 connected to the four signal processing circuits 50. The computer 650 is, for example, a microcomputer. An example of the configuration of the computer 650 will be described below.

The computer 650 includes a central processing unit: CPU 651 that is a processor serving as an example of a processing portion. In addition, the computer 650 includes a read-only memory: ROM 652 storing a program 620 for causing the CPU 651 to perform arithmetic processing for obtaining a torque value τ, and a random access memory: RAM 653 used for temporarily storing data and so forth. In addition, the computer 650 includes I/O 654 that is an interface to the signal processing circuits 50 and external devices connected thereto such as the robot control device 300 and an unillustrated external storage. The CPU 651, the ROM 652, the RAM 653, and the I/O 654 are mutually communicably interconnected via a bus 660.

The torque value τ is torque information, that is, torque data, and may be a standardized value. The CPU 651 obtains phase information from each signal processing circuit 50, obtains the torque value τ by performing arithmetic processing in accordance with the program 620, and outputs the obtained torque value τ to the robot control device 300.

In the present embodiment, a storage device 670 includes the ROM 652 and the RAM 653 and serves as an example of a storage portion. To be noted, the configuration of the storage device 670 is not limited to this. In addition, the storage device 670 may be an internal storage, an external storage, or a combination of an internal storage and an external storage.

In addition, although the ROM 652 is a non-transitory recording medium that is readable for the computer 650 and the ROM 652 stores the program 620 in the present embodiment, the configuration is not limited to this. The program 620 may be recorded in any recording medium as long as the recording medium is a non-transitory recording medium that is readable for the computer 650. In addition, as the recording medium for supplying the program 620 to the computer 650, for example, flexible disks, optical disks, magneto-photo disks, magnetic tapes, and nonvolatile memories can be used.

The arithmetic processing unit 600 obtains relative displacement information between the support portions 501 and 502 on the basis of a detection signal that is an encoder signal from the sensor head 7 of each of the encoders 510. Then, the arithmetic processing unit 600 converts the obtained displacement information into the torque value τ, and outputs the torque value τ to the robot control device 300.

FIG. 5B is a block diagram illustrating a function of the torque sensor 500 according to the first embodiment.

The torque sensor 500 includes a plurality of, for example, four encoder devices 550 as an example of a plurality of displacement detection devices. The encoder devices 550 each include the encoder 510, the signal processing circuit 50, and a partial function of the computer 650 illustrated in FIG. 5A. When the CPU 651 illustrated in FIG. 5A executes the program 620, the CPU 651 functions as each displacement calculation portion 680 and a torque calculation portion 681 illustrated in FIG. 5B. That is, the CPU 651 functions as the displacement calculation portion 680 of each of the encoder devices 550. In addition, the CPU 651 functions as a torque calculation portion 681 of the torque sensor 500 that calculates the torque value τ by using a phase Φ10 that is displacement information calculated by each displacement calculation portion 680. The arithmetic processing of the phase Φ10 by each displacement calculation portion 680 will be described later. The phase Φ10 is relative displacement information of the support portion 501 with respect to the support portion 502 derived from elastic deformation of the elastic portion 503 caused by the torque acting on the sensor body 590, and does not include elastic deformation of the support portion 501.

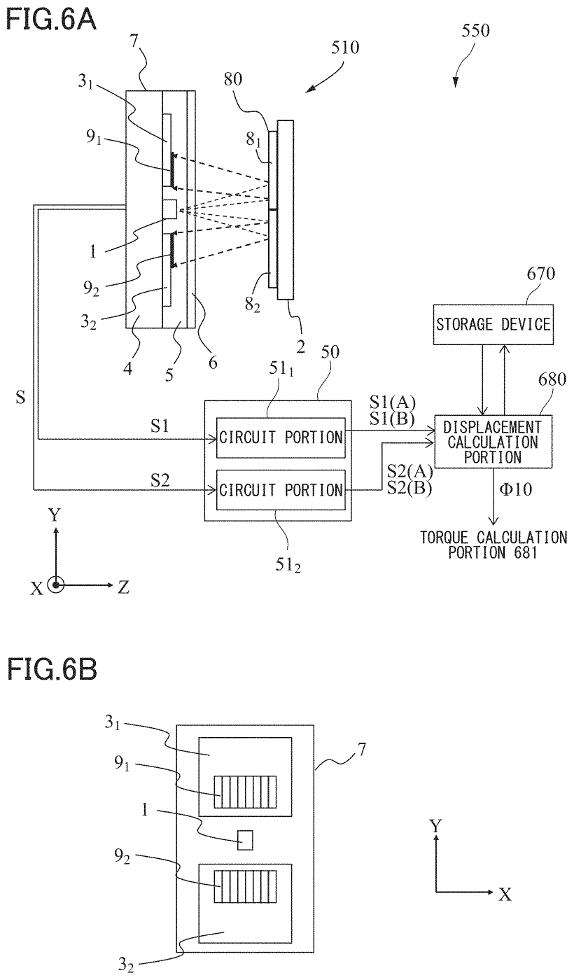

FIG. 6A is a schematic view of the encoder device 550 according to the first embodiment. The scale 2 relatively translationally moves in an X direction with respect to the sensor head 7. The movement direction of the scale 2 relatively translationally moving with respect to the sensor head 7 will be referred to as an X direction, a direction intersecting with the X direction will be referred to as a Y direction, and a direction intersecting with the X direction and the Y direction will be referred to as a Z direction. The X direction, the Y direction, and the Z direction are preferably perpendicular to each other. The X direction is a tangential direction. The Y direction is a radial direction. The X direction serves as an example of a first direction, and the Y direction serves as an example of a second direction. The X direction is also a position measurement direction of the encoder 510. FIG. 6A schematically illustrates the scale 2 and the sensor head 7 as viewed in the X direction. In addition, FIG. 6B is a plan view of the sensor head 7 according to the first embodiment. FIG. 6B schematically illustrates the sensor head 7 as viewed in the Z direction.

The encoder 510 is an optical encoder of a light interference type, and is an incremental linear encoder. In addition, although the encoder 510 is of a reflection type in the first embodiment, the encoder 510 may be of a transmission type. The CPU 651 performs processing such as interpolation of a detection signal S obtained from the sensor head 7, writing and reading of information into and from the storage device 670, and output of a position signal.

The sensor head 7 is disposed at a position opposing the scale 2 in the Z direction. The scale 2 has a pattern portion 80. The sensor head 7 reads the pattern portion 80 of the scale 2 and outputs the detection signal S to the signal processing circuit 50. The sensor head 7 includes a light source 1 constituted by a light emitting diode: LED serving as an example of a light emitting unit, and two light receiving units 3₁ and 3₂. The light receiving units 3₁ and 3₂ are arranged at a distance from the light source 1 in the Y direction. In the first embodiment, the light source 1 is disposed between the two light receiving units 3₁ and 3₂. To be noted, although it is preferable to use the same units for the light receiving units 3₁ and 3₂ because the same parts can be used and the costs can be reduced, different types of light receiving units suitable for respective modulation periods of tracks that the light receiving units respectively read may be used.

The light receiving unit 3₁ includes a light receiving element array 9₁, and the light receiving unit 3₂ includes a light receiving element array 9₂. The light source 1 and the light receiving units 3₁ and 3₂ are mounted on a printed wiring board 4, and are sealed by transparent resin 5 that transmits light. Transparent glass 6 that transmits light is disposed on the surface of the resin 5. According to this configuration, the light source 1 and the light receiving units 3₁ and 3₂ are protected by the resin 5 and the glass 6.

The signal processing circuit 50 is constituted by, for example, a semiconductor element constituted by an integrated circuit chip: IC chip. The signal processing circuit 50 is mounted on, for example, the surface of the printed wiring board 4. To be noted, the position of the signal processing circuit 50 is not limited to this, and the signal processing circuit 50 may be disposed at a position different from a position on the printed wiring board 4. In FIG. 6A, the signal processing circuit 50 is disposed at a position different from a position on the printed wiring board 4 for the sake of convenience of description. The signal processing circuit 50 includes a circuit portion 51₁ that processes a detection signal S1 obtained from the light receiving element array 9₁, and a circuit portion 51₂ that processes a detection signal S2 obtained from the light receiving element array 9₂. The detection signals S1 and S2 are included in the detection signal S.

As illustrated in FIG. 6A, the pattern portion 80 includes two scale tracks 8₁ and 8₂. The two scale tracks 8₁ and 8₂ are arranged side by side in the Y direction. Diverging light beams emitted from the light source 1 are diagonally radiated onto the scale tracks 8₁ and 8₂ of the scale 2. The light beams respectively reflected by the scale tracks 8₁ and 8₂ are respectively reflected toward the light receiving element arrays 9₁ and 9₂. Respective reflection light is diagonally incident on the respective light receiving element arrays 9₁ and 9₂. Reflection light having a light amount distribution is received as an image on each of the light receiving element arrays 9₁ and 9₂. Specifically, the amount of light received by the light receiving element arrays 9₁ and 9₂ is smaller at a position farther from the light source 1 in the Y direction.

The light beams received by the light receiving element arrays 9₁ and 9₂ are converted into electric signals. The electric signals are respectively transmitted to the circuit portions 51₁ and 51₂ of the signal processing circuit 50 as respective detection signals S1 and S2.

Incidentally, in the first embodiment, the support portion 501 of the sensor body 590 illustrated in FIG. 4 is attached to and fixed to the flex spline 153 of the reduction gear 143 illustrated in FIG. 2. The flex spline 153 is elliptically deformed by the wave generator 151, and thus the deformation force thereof is also transmitted to the support portion 501. Therefore, the support portion 501 is deformed by the deformation force.

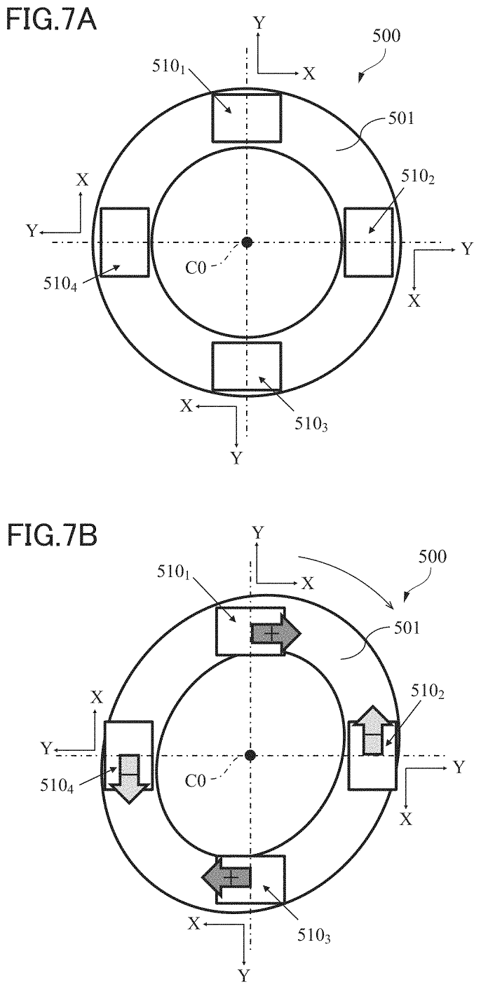

FIGS. 7A and 7B are explanatory diagrams of the torque sensor 500 as viewed in the direction in which the rotation axis C0 extends. FIG. 7A illustrates a state in which the deformation force of the flex spline 153 of the reduction gear 143 illustrated in FIG. 2 is not transmitted to the support portion 501 of the torque sensor 500. FIG. 7B illustrates a state in which the deformation force of the flex spline 153 of the reduction gear 143 illustrated in FIG. 2 is transmitted to the support portion 501 of the torque sensor 500. FIGS. 7A and 7B illustrate the four encoders 510 as encoders 510₁, 510₂, 510₃, and 510₄. The encoders 510₁, 510₂, 510₃, and 510₄ are arranged at equal intervals at positions with 90-degree symmetry with respect to the rotation axis C0.

If the deformation force of the flex spline 153 is not acting on the support portion 501 of the torque sensor 500, the support portion 501 keeps the annular shape as illustrated in FIG. 7A. The encoders 510₁, 510₂, 510₃, and 510₄ can accurately detect the displacement in the X direction.

When the torque sensor 500 is applied to a joint of the robot 200, the deformation force of the flex spline 153 acts on the support portion 501 of the torque sensor 500. As a result of this, the support portion 501 is also elliptically deformed similarly to the flex spline 153 as illustrated in FIG. 7B. When the wave generator 151 is rotated in an arrow direction to drive the joint of the robot arm 201, the elliptical shape of the flex spline 153, that is, the elliptical shape of the support portion 501 also rotates in the arrow direction. Further, the elliptical shape of the support portion 501 rotates at a frequency as twice as high as the number of rotations of the wave generator 151. The scale 2 of each of the encoders 510₁, 510₂, 510₃, and 510₄ is fixed to the support portion 501. That is, when the joint of the robot arm 201 is rotated, the scale 2 periodically relatively moves in the X direction and the Y direction with respect to the sensor head 7 at a frequency as twice as high as the number of rotations of the wave generator 151 in each of the encoders 510₁ to 510₄.

For example, it is assumed that the elliptical shape of the support portion 501 rotates clockwise about the rotation axis C0 as illustrated in FIG. 7B. In the encoders 510₁ and 510₃, the scale 2 is relatively displaced in the +X direction with respect to the sensor head 7 similarly to a case where a torque is applied in the clockwise direction. In contrast, in the encoders 510₂ and 510₄, the scale 2 is relatively displaced in the −X direction with respect to the sensor head 7 similarly to a case where a torque is applied in the counterclockwise direction.

As described above, in the displacement of the scale 2 of each of the encoders 510₁ to 510₄, an error derived from the elliptical deformation of the support portion 501 is superimposed on the torque actually applied to the joint of the robot arm 201. Since the torque sensor 500 includes the four encoders 510₁ to 510₄, the error can be reduced to a certain extent by averaging the values detected by these. However, since the amount of displacement derived from the elliptical deformation varies among the encoders 510₁ to 510₄, the error cannot be eliminated by just the averaging processing.

Therefore, in the first embodiment, the displacement in the Y direction is also measured in the encoders 510₁ to 510₄, and a measured value of the displacement in the X direction is corrected on the basis of a measured value of the displacement in the Y direction to calculate an accurate torque value.

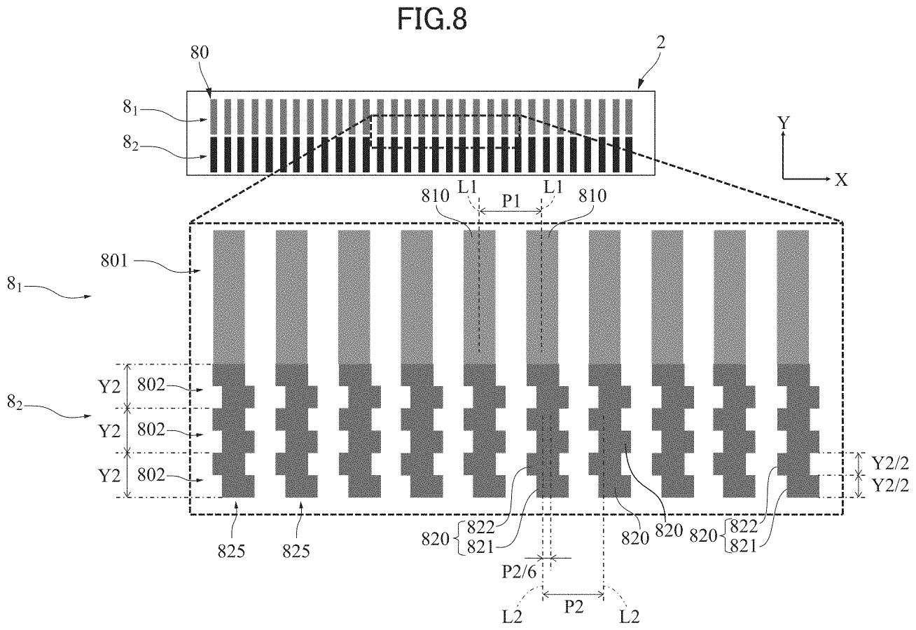

FIG. 8 is an explanatory diagram of the scale 2 according to the first embodiment. FIG. 8 illustrates the entirety of the scale 2, and an enlarged view of part of the scale 2. The scale 2 includes a substrate such as glass. The pattern portion 80 is formed by patterning a chromium film on the substrate. To be noted, the substrate of the scale 2 may be resin such as polycarbonate, or metal such as stainless steel. In addition, it suffices as long as the pattern portion 80 functions as a reflection film, and the pattern portion 80 may be formed from, for example, aluminum.

The pattern of the scale track 81 of the pattern portion 80 is read by the light receiving element array 9₁. The pattern of the scale track 8₂ of the pattern portion 80 is read by the light receiving element array 9₂. The scale track 8₁ includes a pattern row 801 as at least one first pattern row. The scale track 8₂ includes a plurality of pattern rows 802 as at least one second pattern row.

The pattern row 801 includes a plurality of pattern elements 810 serving as a plurality of first pattern elements periodically arranged in the X direction. The plurality of pattern elements 810 are arranged at intervals in the X direction at a predetermined pitch P1 serving as a modulation period. The plurality of pattern elements 810 each have a shape symmetrical with respect to an axis L1 serving as a first axis extending in the Y direction.

The pattern rows 802 each include a plurality of pattern elements 820 serving as a plurality of second pattern elements periodically arranged in the X direction. The plurality of pattern elements 820 are arranged at intervals in the X direction at a predetermined pitch P2 serving as a modulation period. The plurality of pattern elements 820 each have a shape asymmetrical with respect to an axis L2 serving as a second axis extending in the Y direction. In the present embodiment, the pitch P1 of the plurality of pattern elements 810 is equal to the pitch P2 of the plurality of pattern elements 820. That is, the interval between two adjacent axes L1 is equal to the interval between two adjacent axes L2.

Here, the pattern element 820 is asymmetrical with respect to every virtual axis extending in the Y direction at every position in the X direction. That is, there is no axis with respect to which the pattern element 820 is in line symmetry. In contrast, the pattern element 810 has one axis with respect to which the pattern element 810 is in line symmetry among virtual axes extending in the Y direction, and that axis is the axis L1.

In the first embodiment, the plurality of pattern rows 802 are continuously arranged in the Y direction. The length of each of the pattern rows 802 in the Y direction will be denoted by Y2. A plurality of pattern elements 820 of one row continuous in the Y direction constitute a pattern element group 825. In the pattern element group 825, the plurality of pattern elements 820 of the same shape are arranged in the Y direction at a period of the length Y2. In the first embodiment, a plurality of pattern element groups 825 are arranged at equal intervals at the pitch P2 in the X direction.

In each pattern row 802, the plurality of pattern elements 820 arranged at intervals in the X direction each include a rectangular portion 821 serving as a first portion and a rectangular portion 822 serving as a second portion disposed at a position displaced from the portion 821 in the X direction. The amount of displacement of the portion 822 in the X direction with respect to the portion 821 is preferably ⅙ of the pitch P2 between two adjacent pattern elements 820 among the plurality of pattern elements 820. In addition, the length of the portion 821 in the Y direction is preferably equal to the length of the portion 822 in the Y direction, that is, the length of each of the portions 821 and 822 in the Y direction is preferably Y2/2.

Although the pitch P1 and the pitch P2 may be different, the pitch P1 and the pitch P2 are preferably equal. The pitch P1 used for measuring the torque is preferably as small as possible. By setting the pitch P1 to be small, high resolution can be achieved for the torque sensor 500. In the description below, a case where the pitches P1 and P2 are 100 μm and the length Y2 is 50 μm will be described.

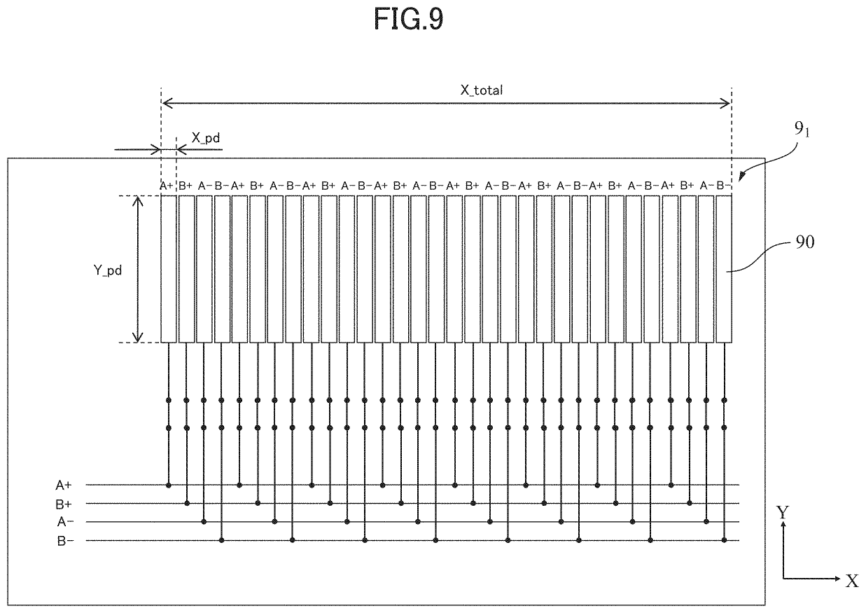

FIG. 9 is a plan view of the light receiving element array 9₁ according to the first embodiment. To be noted, the configuration of the light receiving element array 9₂ is substantially the same as the light receiving element array 9₁, and thus illustration and description thereof will be omitted. The light receiving element array 9₁ includes a plurality of, for example, 32 light receiving elements 90 arranged at a pitch of 50 μm in the X direction. The light receiving elements 90 each have a width X_pd in the X direction of 50 μm, and a width Y_pd in the Y direction of 800 μm. A total width X_total of the light receiving element array 9₁ is 1600 μm.

The pattern on the scale 2 is projected as an image doubled in size on the light receiving element array 9₁. Therefore, the detection range on the scale 2 is a range of 800 μm in the X direction and 400 μm in the Y direction. On the light receiving element array 9₂, due to the relationship between the width Y_pd and the length Y2, the detection range on the scale 2 is 8 pattern rows 802. To be noted, in the case where the value of Y_pd/Y2 is not an integer, the phase in the X direction varies depending on the detection position in the Y direction. Therefore, the value of Y_pd/Y2 is preferably an integer such that the position in the Y direction does not affect the detection phase in the X direction. The respective detection signals of the light receiving element arrays 9₁ and 9₂ are respectively output to the circuit portions 51₁ and 51₂ illustrated in FIG. 6A.

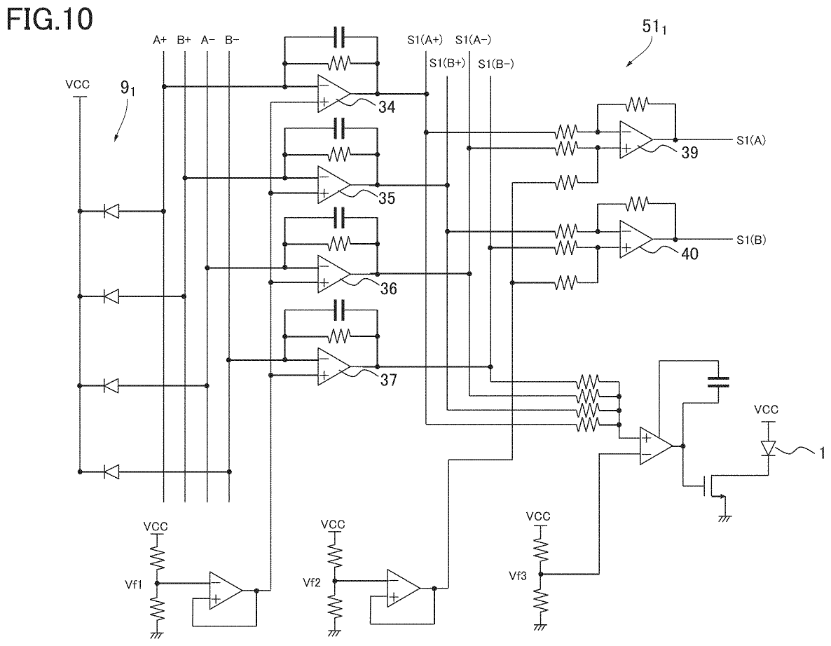

FIG. 10 is a circuit diagram of the circuit portion 51₁ of the signal processing circuit 50 in the first embodiment. To be noted, since the circuit portion 51₂ have substantially the same configuration as the circuit portion 51₁, illustration and description of the circuit portion 51₂ will be omitted.

In the stage following the light receiving element array 9₁, four I-V conversion amplifiers 34, 35, 36, and 37 serving as first stage amplifiers are provided. The I-V conversion amplifiers 34, 35, 36, and 37 generate four-phase sine wave outputs S1(A+), S1(B+), S1(A−), and S1(B−) from the detection signal that is a current signal read from each light receiving element 90 of the light receiving element array 9₁. Regarding the relative phase of the four-phase sine waves, when S1(A+) is set as the standard with respect to the detection pitch, the phase of S1(B+) is about +90°, S1(A−) is about +180°, and the phase of S1(B−) is about +270°.

In a stage following the I-V conversion amplifiers 34, 35, 36, and 37, an A-phase differential amplifier 39 and a B-phase differential amplifier 40 are provided. The A-phase differential amplifier 39 and the B-phase differential amplifier 40 perform calculation of the following formulae (1) and (2) by using the four-phase sine wave outputs S1(A+), S1(B+), S1(A−), and S1(B−). As a result of this, the A-phase differential amplifier 39 and the B-phase differential amplifier 40 generate two-phase sine wave signals S1(A) and S1(B) from which direct current components have been removed.

S1(A)=S1(A+)−S1(A−) (1)

S1(B)=S1(B+)−S1(B−) (2)

In a stage following the A-phase differential amplifier 39 and the B-phase differential amplifier 40, the computer 650 illustrated in FIG. 5A is provided, and the two-phase sine wave signals S1(A) and S1(B) are output to the computer 650.

As described above, the circuit portion 51₁ illustrated in FIG. 6A generates the two-phase sine wave signals S1(A) and S1(B) obtained by removing direct current components from the detection signal S1 obtained from the light receiving element array 9₁. Similarly to the circuit portion 51₁, the circuit portion 51₂ generates two-phase sine wave signals S2(A) and S2(B) obtained by removing direct current components from the detection signal S2 obtained from the light receiving element array 9₂.

Here, the pattern of the pattern row 801 of FIG. 8 is a pattern detected as displacement in the X direction by the sensor head 7 when the sensor head 7 and the scale 2 are relatively displaced from each other in the X direction. To be noted, the pattern of the pattern row 801 is a pattern not detected as displacement in the X direction by the sensor head 7 when the sensor head 7 and the scale 2 are relatively displaced from each other in the Y direction.

In addition, the pattern of the pattern rows 802 is a pattern detected as displacement in the X direction by the sensor head 7 when the sensor head 7 and the scale 2 are relatively displaced from each other in the X direction. Further, the pattern of the pattern rows 802 is a pattern detected as displacement in the X direction by the sensor head 7 when the sensor head 7 and the scale 2 are relatively displaced from each other in the Y direction.

In the first embodiment, the computer 650 obtains the torque value τ from which the error derived from the elliptical deformation of the support portion 501 has been removed by using the sine wave signals S1(A), S1(B), S2(A), and S2(B) that are phase information based on the detection signals S1 and S2 from the sensor head 7. Among the phase information, the sine wave signals S1(A) and S1(B) serve as first information, and the sine wave signals S2(A) and S2(B) serve as second information.

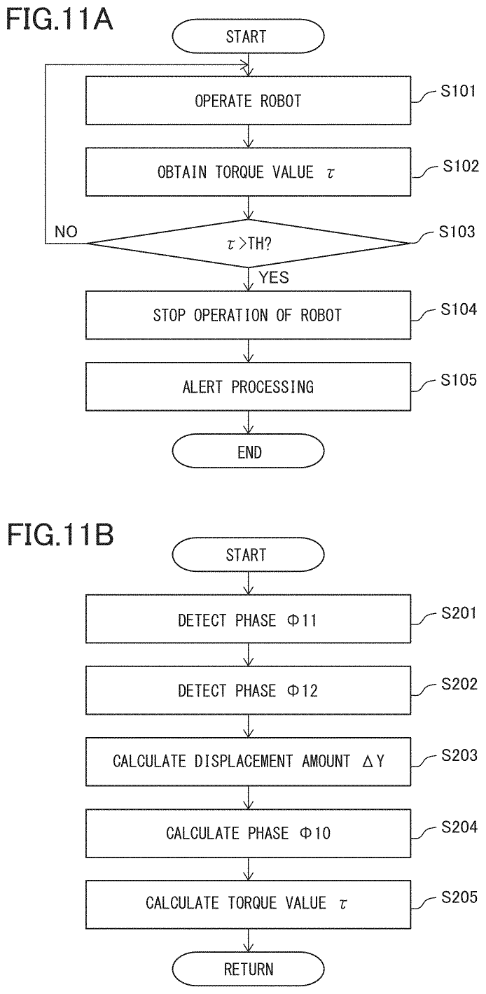

A control method for the robot 200 according to the first embodiment, and a torque detection method for the torque sensor 500 will be described in detail. FIG. 11A is a flowchart illustrating an example of a control method for the robot 200 according to the first embodiment.

First, the control method for the robot 200 will be described with reference to the flowchart illustrated in FIG. 11A. In step S101, the robot control device 300 controls the robot 200 such that the robot 200 operates in accordance with trajectory data corresponding to a robot program including teaching data. At this time, the robot control device 300 supplies a driving current to the motor 141 of each of the joints J1 to J3 to drive the joints J1 to J3. A torque that is a load may be applied to or not applied to the joints J1 to J3 from the outside.

In step S102, the robot control device 300 obtains the torque value τ from the torque sensor 500 during control of the robot 200.

Next, in step S103, the robot control device 300 determines whether or not the torque value τ is larger than a threshold value TH. That is, whether or not the robot 200 has touched an operator or an object around the robot 200. If the robot 200 touches something, the torque value τ exceeds the threshold value TH.

In the case where the torque value τ is equal to or smaller than the threshold value TH, that is, in the case where the result of step S103 is NO, the robot control device 300 returns to the processing of step S101, and controls the robot 200.

In the case where the torque value τ is greater than the threshold value TH, that is, in the case where the result of step S103 is YES, in step S104, the robot control device 300 stops the operation of the robot 200. In addition, in step S105, the robot control device 300 performs alert processing. In the present embodiment, since the robot system 100 includes three torque sensors 500, the robot control device 300 transitions to the processing of steps S104 and S105 if any one of the three torque values exceeds the threshold value TH.

Examples of a method for stopping the operation of the robot 200 include quick stop, slow stop, moving in a reversed direction, and switching to impedance control. In addition, as the alert processing, for example, the robot control device 300 causes the robot 200 to output an error signal or an alert, displays the torque value τ on a terminal such as the teaching pendant 400, or obtain a log and store the log in a storage portion in the robot control device 300.

To be noted, the order of the processing of step S104 and the processing of step S105 may be reversed, or the processing of step S104 and the processing of step S105 may be performed simultaneously. In addition, one of the processing of step S104 and the processing of step S105 may be omitted.

The torque value τ obtained by the robot control device 300 in step S102 is detected as follows. FIG. 11B is a flowchart illustrating an example of a torque detection method according to the first embodiment. Here, steps S201 to S204 illustrated in FIG. 11B are arithmetic processing of each displacement calculation portion 680 illustrated in FIG. 5B, and step S205 is arithmetic processing of the torque calculation portion 681 illustrated in FIG. 5B. Since each displacement calculation portion 680 illustrated in FIG. 5B performs substantially the same calculation, one of the plurality of displacement calculation portions 680 will be described in the description of processing of steps S201 to S204 below.

In step S201, the displacement calculation portion 680 detects, from the pattern row 801, phase Φ11 indicating the amount of displacement in the X direction. That is, the displacement calculation portion 680 obtains, as the phase Φ11, a first displacement amount of the scale 2 in the X direction relative to the sensor head 7 by using the sine wave signals S1(A) and S1(B) obtained from the circuit portion 51₁. The phase Φ11 is obtained in accordance with the following formula (3).

Φ11=A TAN 2 [S1(A), S1(B)] (3)

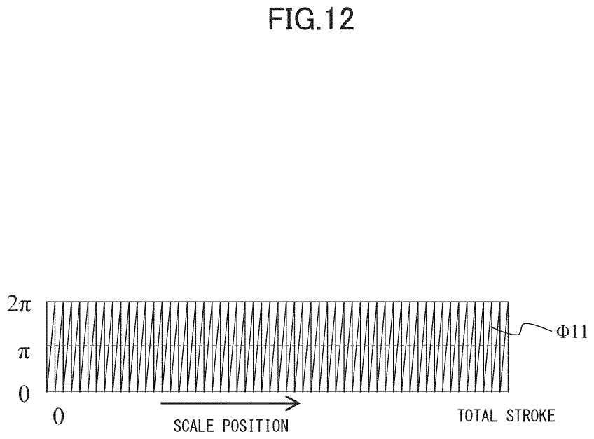

A TAN 2[Y, N is an arc tangent calculation function that determines the orthant and performs conversion into 0 to 2π phase. The phase Φ11 and the position of the scale 2 have a relationship illustrated in a graph of FIG. 12.

To be noted, before performing the calculation of the formula (3), gain ratio and offset errors derived from offset, gain variation, and the like of each amplifier and included in the sine wave signals S1(A) and S1(B) may be corrected by using correction values obtained in advance. For example, for each of the sine wave signals S1(A) and S1(B), the gain ratio, that is, the amplitude ratio may be calculated by (maximum value−minimum value)/2 to calculate a correction value for equalizing the signal amplitude. Similarly, the offset error amount may be calculated by (maximum value+minimum value)/2 to calculate a correction value to correct the offset error. These correction values may be stored in the storage device 670.

Incidentally, the phase Φ11 includes an error Φ10′ in the X direction derived from relative displacement of the scale 2 in the X direction with respect to the sensor head 7 caused by the elliptical deformation of the support portion 501. To be noted, even if the scale 2 is relatively displaced in the Y direction with respect to the sensor head 7 due to the elliptical deformation of the support portion 501, the phase Φ11 is not affected.

That is, when a phase that is supposed to be obtained if the support portion 501 is not elliptically deformed and that does not include the error Φ10′ derived from the elliptical deformation is denoted by Φ10, the phase Φ11 satisfies the following formula (4).

Φ11=Φ10+Φ10′ (4)

For example, the phase Φ10 is zero in a state in which no torque is applied to the torque sensor 500, but the phase Φ11 that is actually detected includes the error Φ10′ due to the elliptical deformation of the support portion 501.

Next, in step S202, the displacement calculation portion 680 detects, from the pattern rows 802, phase Φ12 that is a displacement amount in the X direction. That is, the displacement calculation portion 680 obtains, as the phase Φ12, a displacement amount of the scale 2 in the X direction relative to the sensor head 7 by using the sine wave signals S2(A) and S2(B) obtained from the circuit portion 512. The phase Φ12 is obtained in accordance with the following formula (5).

Φ12=A TAN 2 [S2(A), S2(B)] (5)

The phase Φ12 includes the error Φ10′ in the X direction derived from relative displacement of the scale 2 in the X direction with respect to the sensor head 7 caused by the elliptical deformation of the support portion 501.

Further, the phase Φ12 includes an error in the Y direction derived from relative displacement of the scale 2 in the Y direction with respect to the sensor head 7 caused by the elliptical deformation of the support portion 501 as an error Φ10″ in the X direction. That is, the phase Φ12 satisfies the following formula (6).

Φ12=Φ10+Φ10′+Φ10″ (6)

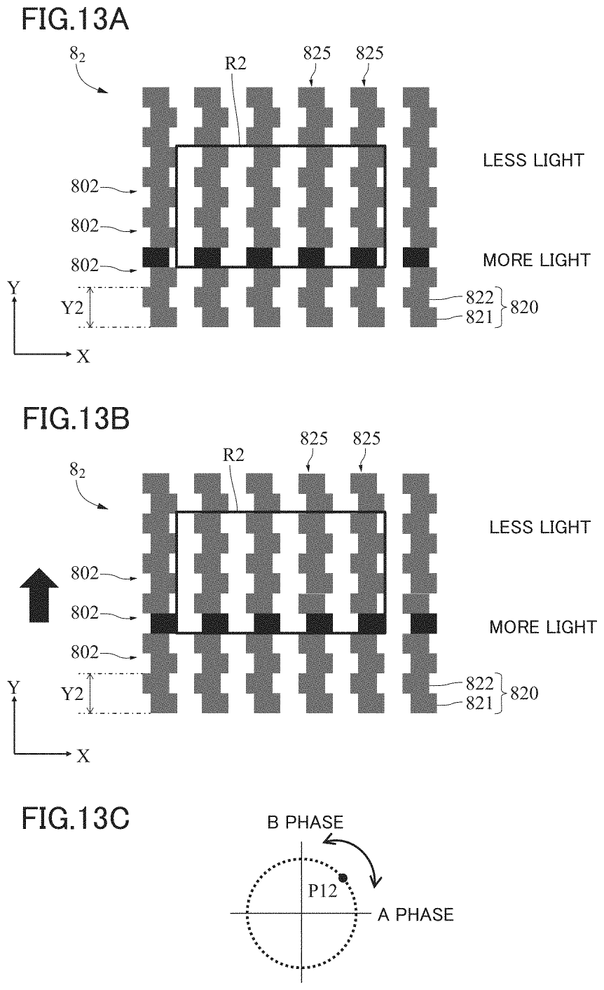

How the error Φ10″ is superimposed on the phase Φ12 will be described below. For the sake of simpler description, description will be given assuming that the scale 2 is only relatively displaced in the Y direction with respect to the sensor head 7 and is not relatively displaced in the X direction. FIGS. 13A and 13B are explanatory diagrams for explaining how the error Φ10″ is superimposed on the phase Φ12 in the first embodiment.

The detection range of the scale track 8₂ will be denoted by R2. Only reflection light from the detection range R2 is received by the light receiving element array 9₂, and reflection light from a region outside of the detection range R2 is not received by the light receiving element array 9₂. In the scale track 8₂, the light emitted from the light source 1 is diagonally incident thereon, and in the light receiving element array 9₂, the reflection light from the scale track 8₂ is diagonally received. Therefore, the amount of light of the reflection light is not distributed evenly in the detection range R2. Among the reflection light from the detection range R2, reflection light of a large light amount greatly affects the light receiving sensitivity of the light receiving element array 9₂. Therefore, the reflection light from a portion where the light amount is large in the detection range R2 is dominant in the detection signal S2 output from the light receiving element array 9₂. Then, when the detection range R2 moves from the state illustrated in FIG. 13A to the state illustrated in FIG. 13B in the Y direction, the detection signal S2 changes in accordance with the shape of the pattern elements 820 asymmetrical with respect to the axis L2 even though the detection range R2 has not moved in the X direction.

In the first embodiment, the pattern element groups 825 each have a periodical shape as a result of the plurality of pattern elements 820 of the same shape being continuous in the Y direction. Therefore, when the detection range R2 moves in the Y direction by an amount equal to or greater than the length Y2, the phase Φ12 also changes periodically. FIG. 13C is a schematic view of a Lissajous waveform according to the first embodiment. The horizontal axis represents the sine wave signal S2(A) among the detection signal S2, and the vertical signal represents the sine wave signal S2(B) among the detection signal S2. When the detection range R2 moves in the Y direction, a point P12 (S2(A), S2(B)) reciprocates in a predetermined range on the circle of the Lissajous waveform.

In the first embodiment, as illustrated in FIG. 8, the displacement amount of the portion 822 in the X direction with respect to the portion 821 is ⅙ of the pitch P2. In the case of such a pattern, in the Lissajous waveform indicated by a broken line illustrated in FIG. 13C, the high-frequency component can be reduced by the principle of optical interference. As described above, since the displacement amount of the portion 822 in the X direction with respect to the portion 821 in the pattern elements 820 is ⅙ of the pitch P2, the phase Φ12 from which a tertiary high-frequency component has been removed and thus which is highly precise can be detected.

In step S203, the displacement calculation portion 680 obtains a displacement amount ΔY serving as a second displacement amount of the scale 2 in the Y direction relative to the sensor head 7. Specifically, first, the displacement calculation portion 680 obtains a difference ΔΦ by subtracting the phase Φ11 from the phase Φ12. The difference ΔΦ is expressed by the following formula (7).

ΔΦ=Φ12−Φ11 (=Φ10″) (7)

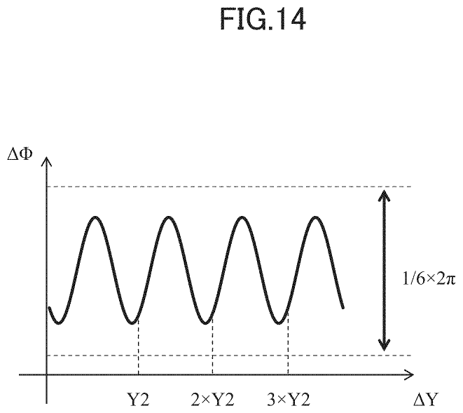

That is, the difference ΔΦ corresponds to the error Φ10″. This means that the displacement calculation portion 680 calculates the error Φ10″ by obtaining the difference ΔΦ. The difference ΔΦ, that is, the error Φ10″ is a value that periodically changes in accordance with the displacement amount ΔY of the scale 2 in the Y direction relative to the sensor head 7. FIG. 14 is a graph illustrating the relationship between the difference ΔΦ and the displacement amount ΔY. The relationship illustrated in FIG. 14 is stored in the storage device 670 in advance. For example, the relationship between the difference ΔΦ and the displacement amount ΔY is stored in the storage device 670 as table data or a calculation formula. The relationship illustrated in FIG. 14 may be, for example, generated by using design values of light distribution characteristics of the light source and design values of the pattern rows 802 of the scale, or may be obtained by conducting experiments. The displacement calculation portion 680 converts the difference ΔΦ into the displacement amount ΔY on the basis of the relationship illustrated in FIG. 14.

The pattern element 820 is a pattern in which the portion 821 and the portion 822 are asymmetrically displaced from each other by ⅙ of the pitch P2. Therefore, the difference between the maximum value and the minimum value of the difference ΔΦ periodically changes in the range of (⅙)×2π [rad] in accordance with relative displacement of the scale 2 in the Y direction with respect to the sensor head 7. The displacement calculation portion 680 counts the number of cycles of the change of the difference ΔΦ that have occurred, and obtains the displacement amount ΔY from the count value at that time and the value of the difference ΔΦ.

In this manner, the displacement calculation portion 680 obtains the phase Φ11 from the sine wave signals S1(A) and S1(B), and obtains the displacement amount ΔY from the phase Φ11 and the sine wave signals S2(A) and S2(B).

Next, the displacement calculation portion 680 obtains the elliptical shape, that is, the ellipticity of the support portion 501 from the displacement amount ΔX in the X direction and the displacement amount ΔY obtained by converting the phase Φ11. Here, the positivity and negativity of the amount of error in the X direction derived from the deformation of the support portion 501 into an elliptical shape is reversed depending on the rotation direction of the wave generator 151 that is an input shaft of the reduction gear 143. Therefore, the displacement calculation portion 680 obtains the information of the rotation direction of the input shaft of the reduction gear 143 in advance from the robot control device 300. Specifically, when the input shaft of the reduction gear 143 rotates clockwise as illustrated in FIG. 7B, it is assumed that the support portion 501 has an elliptical shape that is a circle deformed in a predetermined angle in the clockwise direction, and the ellipticity is a positive value. In contrast, when the input shaft of the reduction gear 143 rotates counterclockwise, it is assumed that the support portion 501 has an elliptical shape that is a circle deformed in a predetermined angle in the counterclockwise direction, and the ellipticity is a negative value.

The displacement calculation portion 680 obtains, on the basis of the ellipticity of the support portion 501 obtained in consideration of the information of the rotation direction of the input shaft of the reduction gear 143, the amount and direction of the error component in the X direction generated as a result of the support portion 501 being deformed in the Y direction.

The displacement calculation portion 680 obtains the difference between the ellipticity of the support portion 501 and the distance from the rotation axis C0 serving as the rotation center of the support portion 501 that is not receiving the deformation force illustrated in FIG. 7A. As a result of this, the error Φ10′ that is the detection error in the X direction affected by the displacement of the support portion 501 based on the elliptical motion of the reduction gear 143 can be obtained.

Next, in step S204, the displacement calculation portion 680 obtains the phase Φ10 from the following formula (8) as displacement information in the X direction corresponding to the torque value τ. The phase Φ10 that is displacement information corresponds to the relative displacement amount of the support portion 501 with respect to the support portion 502 derived from the elastic deformation of the elastic portion 503 in which the error derived from the elastic deformation of the support portion 501 is canceled.

Φ10=Φ11−Φ10′ (8)

Then, in step S205, the torque calculation portion 681 calculates the torque value τ on the basis of four phases Φ10 respectively obtained for the four encoders 510. For example, the torque calculation portion 681 averages the four phases Φ10, and calculates the torque value τ by, for example, multiplying the average value by a predetermined coefficient such as a sensitivity coefficient proportional to an elastic modulus of the elastic portion 503. To be noted, the method for calculating the torque value τ is not limited to this, and the torque value τ may be alternatively obtained by converting each phase Φ10 into a provisional torque value and averaging the four provisional torque values. The displacement calculation portion 680 outputs the calculated torque value τ to the robot control device 300.

As described above, according to the first embodiment, the torque value τ can be obtained with high precision even in the case where the deformation force derived from the elliptical deformation of the reduction gear 431 is applied to the torque sensor 500 included in the joint of the robot 200. That is, the detection precision of the torque value τ is improved. Since the detection precision of the torque value τ is improved, the operation precision of the robot 200 can be improved. For example, by using the torque value τ for determining whether to stop the operation of the robot 200, the operation of the robot 200 can be quickly stopped when the robot 200 touches the operator or an object. In addition, in the case of performing force control of the robot 200 by using the torque value τ, the operation of the robot 200 can be controlled with high precision.

In addition, the order of processing of step S201 and processing of step S202 is not limited to the order described above, and the processing of step S201 may be executed after the processing of step S202, or these may be executed simultaneously if possible.

### MODIFICATION EXAMPLE

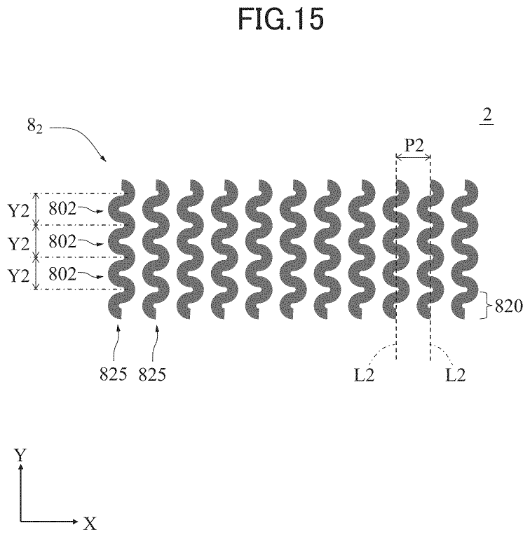

A modification example will be described. FIG. 15 is a plan view of a scale track 8₂ of the scale 2 according to the modification example. The scale track 8₂ of the modification example includes a plurality of pattern rows 802. The plurality of pattern rows 802 are continuously arranged in the Y direction. The length of each pattern row 802 in the Y direction will be denoted by Y2. In the scale track 8₂, focusing on a plurality of pattern elements 820 of one row continuous in the Y direction, the plurality of pattern elements 820 of the same shape are arranged in the Y direction at a period of the length Y2. The plurality of pattern elements 820 continuously arranged in line in the Y direction constitutes a pattern element group 825. In the modification example, a plurality of pattern element groups 825 are arranged at equal intervals of the pitch P2 in the X direction. Each pattern element 820 in each pattern row 802 is preferably asymmetrical with respect to an axis L2, and may have, for example, a wavy shape as illustrated in FIG. 15.

### Second Embodiment

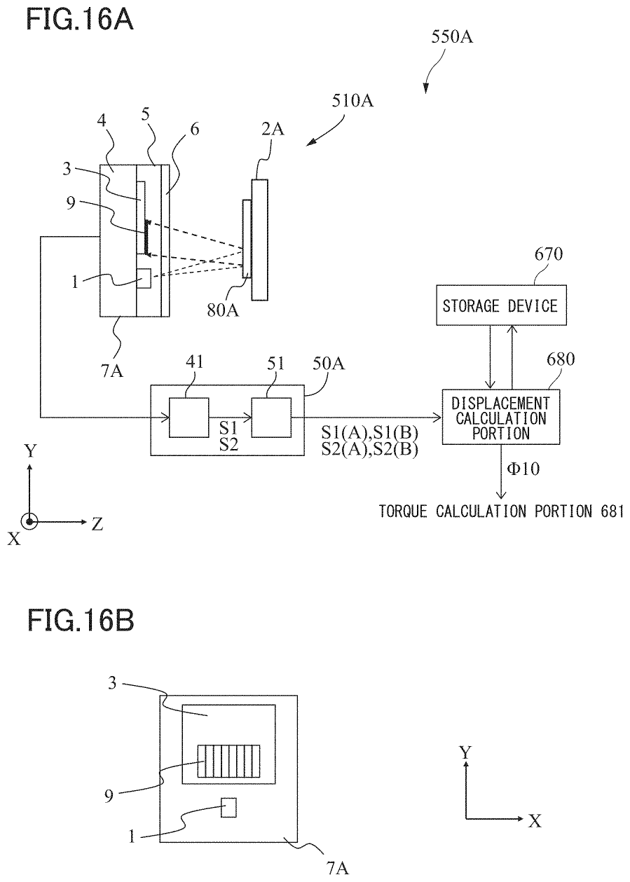

A second embodiment will be described. FIG. 16A is a schematic view of an encoder device 550A serving as an example of a displacement detection device according to the second embodiment. To be noted, in the second embodiment, elements substantially the same as in the first embodiment will be denoted by the same reference signs and description thereof will be omitted. The encoder device 550A includes an encoder 510A, a signal processing circuit 50A, and the displacement calculation portion 680 and the storage device 670 similarly to the first embodiment.

In the second embodiment, the encoder 510A illustrated in FIG. 16A is used instead of the encoder 510 in the torque sensor 500 illustrated in FIG. 4 in the robot system 100 illustrated in FIG. 1. Description will be given below with reference to also drawings described in the first embodiment as appropriate.

The encoder 510A may be a linear encoder or a rotary encoder, but is a linear encoder also in the second embodiment similarly to the first embodiment. In addition, the encoder 510A is an optical encoder of a light interference type, and is an incremental encoder. In addition, although the encoder 510A is of a reflection type in the second embodiment, the encoder 510A may be of a transmission type.

The encoder 510A includes a scale 2A, and a sensor head 7A disposed at a position to oppose the scale 2A in the Z direction. The scale 2A includes a pattern portion 80A. FIG. 16B is a plan view of the sensor head 7A according to the second embodiment.

The sensor head 7A reads the pattern portion 80A of the scale 2A and outputs the detection signal S to the signal processing circuit 50A. The sensor head 7A includes a light source 1 constituted by an LED serving as an example of a light emitting unit, and one light receiving unit 3. The light receiving unit 3 has substantially the same configuration as the light receiving unit 3₁ described in the first embodiment. That is, in the second embodiment, the size of the sensor head 7A is reduced by omitting the light receiving unit 3₂.

The light receiving unit 3 is disposed at a distance from the light source 1 in the Y direction. The light receiving unit 3 includes the light receiving element array 9. The light source 1 and the light receiving unit 3 are mounted on the printed wiring board 4, and sealed by the transparent resin 5 that transmits light. The transparent glass 6 that transmits light is disposed on the surface of the resin 5. According to this configuration, the light source 1 and the light receiving unit 3 are protected by the resin 5 and the glass 6.

The signal processing circuit 50A is constituted by, for example, a semiconductor element constituted by an IC chip. The signal processing circuit 50A is mounted on, for example, the surface of the printed wiring board 4. To be noted, the position of the signal processing circuit 50A is not limited to this, and the signal processing circuit 50A may be disposed at a position different from a position on the printed wiring board 4. In FIG. 16A, the signal processing circuit 50A is disposed at a position different from a position on the printed wiring board 4 for the sake of convenience of description. The signal processing circuit 50A includes a switch circuit 41 that outputs the detection signals S1 and S2 from the light receiving element array 9 while switching therebetween, and a circuit portion 51. The circuit configuration of the circuit portion 51 is substantially the same as the circuit portion 51₁ described in the first embodiment.

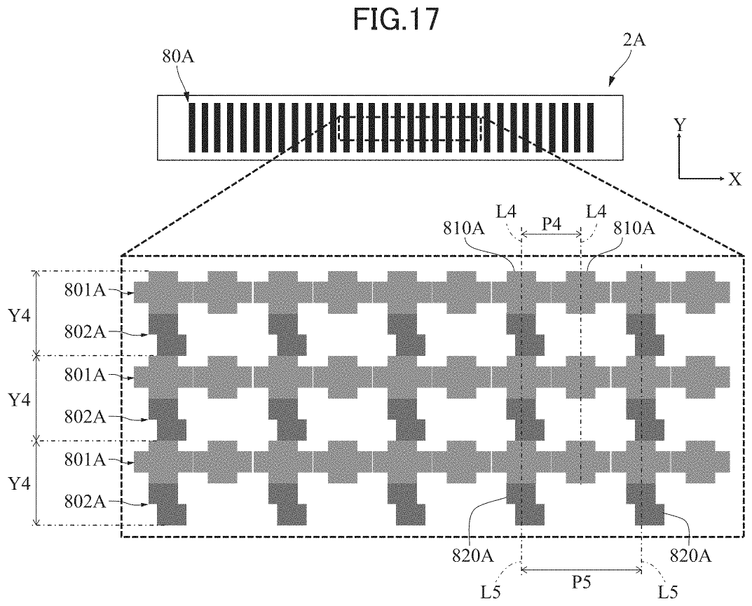

FIG. 17 is an explanatory diagram of the scale 2A according to the second embodiment. FIG. 17 illustrates the entirety of the scale 2A, and an enlarged view of part of the scale 2A. The scale 2A includes a substrate such as glass. The pattern portion 80A is formed by patterning a chromium film on the base material. To be noted, the substrate of the scale 2A may be resin such as polycarbonate or metal such as stainless steel. In addition, it suffices as long as the pattern portion 80A functions as a reflection film, and the pattern portion 80A may be formed from, for example, aluminum.

The pattern of the pattern portion 80A is read by the light receiving element array 9. The pattern portion 80A includes a plurality of pattern rows 801A as at least one first pattern row. In addition, the pattern portion 80A includes a plurality of pattern rows 802A as at least one second pattern row.

The pattern rows 801A each include a plurality of pattern elements 810A serving as a plurality of first pattern elements periodically arranged in the X direction. The plurality of pattern elements 810A are arranged at intervals in the X direction at a predetermined pitch P4 serving as a modulation period. The plurality of pattern elements 810A each have a shape symmetrical with respect to an axis L4 serving as a first axis extending in the Y direction.

The pattern rows 802A each include a plurality of pattern elements 820A serving as a plurality of second pattern elements periodically arranged in the X direction. The plurality of pattern elements 820A are arranged at intervals in the X direction at a predetermined pitch P5 serving as a modulation period. The plurality of pattern elements 820A each have a shape asymmetrical with respect to an axis L5 serving as a second axis extending in the Y direction. In the present embodiment, the pitch P4 of the plurality of pattern elements 810A is different from the pitch P5 of the plurality of pattern elements 820A. For example, the pitch P4 is 100 μm, and the pitch P5 is 200 μm. To be noted, a pattern row different from the pattern rows 801A and 802A may be included in the pattern portion 80A.

In the second embodiment, the plurality of pattern rows 801A and the plurality of pattern rows 802A are alternately arranged in the Y direction. The length of one pair of the pattern row 801A and the pattern row 802A in the Y direction will be denoted by Y4. The pattern portion 80A is configured such that the same shape is repeated at a period of the length Y4 in the Y direction.

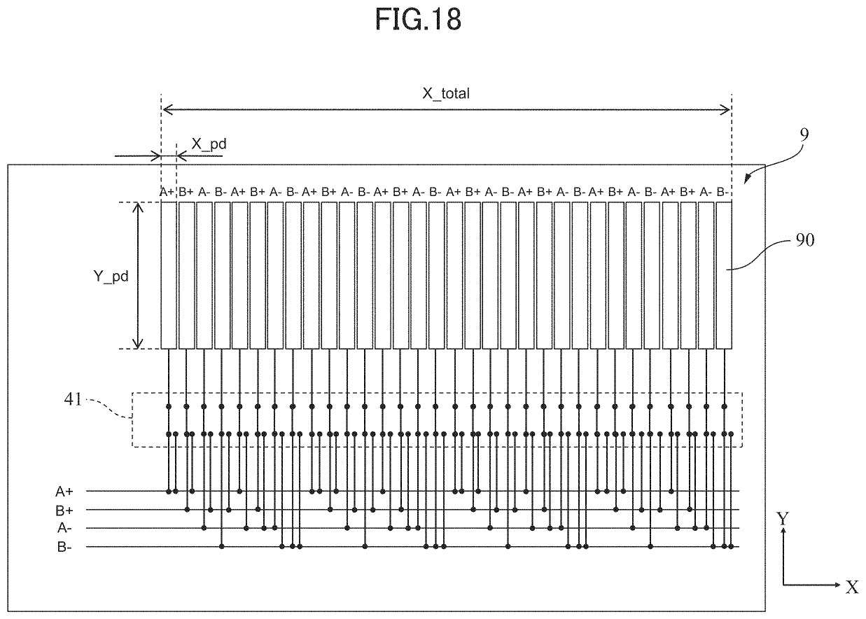

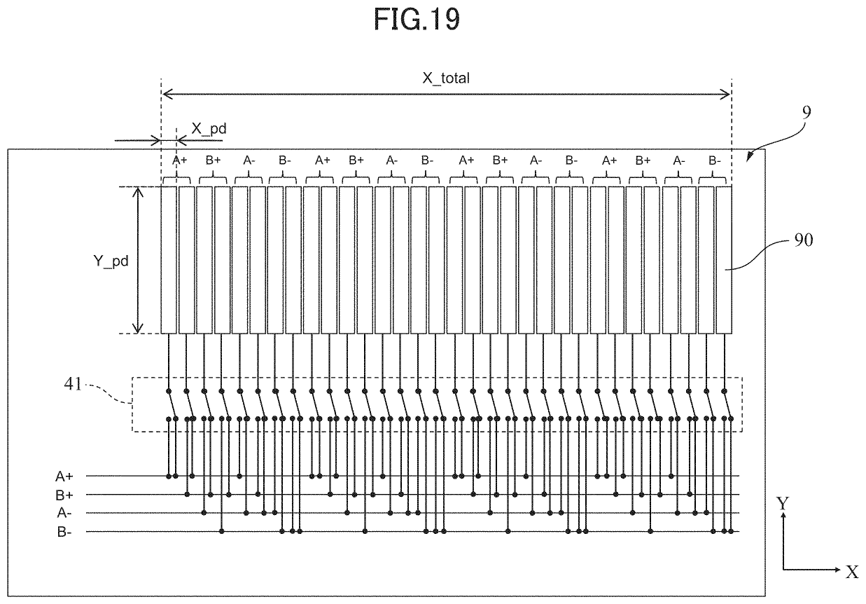

FIGS. 18 and 19 are each a plan view of the light receiving element array 9 according to the second embodiment. The light receiving element array 9 includes a plurality of, for example, 32 light receiving elements 90. The light receiving elements 90 each have a width X_pd in the X direction of 50 μm, and a width Y_pd in the Y direction of 800 μm. A total width X_total of the light receiving element array 9 is 1600 μm. To be noted, in the case where the value of Y_pd/Y4 is not an integer, the phase in the X direction varies depending on the detection position in the Y direction. Therefore, the value of Y_pd/Y4 is preferably an integer such that the position in the Y direction does not affect the detection phase in the X direction. In the pattern portion 80A, it is preferable that the total area of a detection range where light is reflected to be incident on the light receiving element array 9 is constant regardless of the position in the Y direction. According to such a configuration, the output light amount of the light source 1 can be controlled on the basis of the sum of S(A+), S(B+), S(A−), and S(B−) obtained for each of the pitch P4 and the pitch P5.

In the second embodiment, the detection resolution can be switched by switching the switch circuit 41. By switching the switch circuit 41, the light receiving element array 9 can separately output the detection signal S1 based on the pattern rows 801A and the detection signal S2 based on the pattern rows 802A. That is, in the second embodiment, the circuit portion 51 can selectively obtain the detection signal S1 or the detection signal S2 from the light receiving element array 9 by switching the switch circuit 41. The circuit portion 51 generates the two-phase sine wave signals S1(A) and S1(B) obtained by removing direct current components from the detection signal S1 obtained from the light receiving element array 9. In addition, the circuit portion 51 generates the two-phase sine wave signals S2(A) and S2(B) obtained by removing direct current components from the detection signal S2 obtained from the light receiving element array 9. To be noted, in the case where a pattern row different from the pattern rows 801A and 802A is included in the pattern portion 80A, the switch circuit 41 may be configured to be switchable among three or more detection resolutions.

Here, the pattern of the pattern rows 801A is a pattern detected as displacement in the X direction by the sensor head 7A when the sensor head 7A and the scale 2A are relatively displaced from each other in the X direction. To be noted, the pattern of the pattern rows 801A is a pattern not detected as displacement in the X direction by the sensor head 7A when the sensor head 7A and the scale 2A are relatively displaced from each other in the Y direction.

In addition, the pattern of the pattern rows 802A is a pattern detected as displacement in the X direction by the sensor head 7A when the sensor head 7A and the scale 2A are relatively displaced from each other in the Y direction.

In the second embodiment, the displacement calculation portion 680 obtains the phase Φ10 for obtaining the torque value τ by the torque calculation portion 681 by using the sine wave signals S1(A), S1(B), S2(A), and S2(B) that are phase information based on the detection signals S1 and S2 from the sensor head 7A. Among the phase information, the sine wave signals S1(A) and S1(B) serve as first information, and the sine wave signals S2(A) and S2(B) serve as second information.

Hereinafter, since the control method for the robot 200 illustrated in FIG. 1 in the second embodiment is substantially the same as the flowchart of the control method illustrated in FIG. 11A described in the first embodiment, description thereof will be omitted. The torque detection method of the torque sensor in the second embodiment is also similar to that of the first embodiment, but since the switching operation by the switch circuit 41 is performed, the torque detection method is different from the first embodiment in that point. That is, the detection method in the second embodiment is substantially the same as the detection method illustrated in FIG. 11B, but the processing of step S201 and the processing of step S202 are performed by being switched by the switch circuit 41. Specifically, the switch circuit 41 is switched to the state illustrated in FIG. 18 in step S201, and the switch circuit 41 is switched to the state illustrated in FIG. 19 in step S202.

In step S201, the switch circuit 41 is switched to the state illustrated in FIG. 18, thus every third light receiving elements in the plurality of light receiving elements 90 are electrically connected to each other, and a current signal is input to one of the I-V conversion amplifiers 34 to 37 illustrated in FIG. 10. As a result of this, a pattern of the pitch P4 is detected.

In step S202, the switch circuit 41 is switched to the state illustrated in FIG. 19, and thus every pair of adjacent light receiving elements in the plurality of light receiving elements 90 are electrically connected to each other, and a current signal is input to one of the I-V conversion amplifiers 34 to 37 illustrated in FIG. 10. As a result of this, a pattern of the pitch P5 is detected.

As described above, by switching the detection resolution by the switch circuit 41, the detection signal S1 based on the periodical pattern of the pitch P4 and the detection signal S2 based on the periodical pattern of the pitch P5 can be selectively output to the circuit portion 51 by using the one light receiving element array 9.

As described above, according to the second embodiment, the torque value τ can be obtained with high precision even in the case where the deformation force derived from the elliptical deformation of the reduction gear 431 is applied to the torque sensor similarly to the first embodiment. That is, the detection precision of the torque value τ is improved. Since the detection precision of the torque value τ is improved, the operation precision of the robot 200 can be improved. In addition, the size of the encoder 510A can be reduced, and thus the size of the torque sensor and the size of the robot can be also reduced.

To be noted, the order of processing of step S201 and step S202 is not limited to the order described above, and the processing of step S201 may be executed after the processing of step S202. In addition, the pattern elements 820A are each preferably asymmetrical with respect to the axis L5, and may have, for example, a wavy shape like the pattern elements 820 illustrated in FIG. 15.

### Third Embodiment

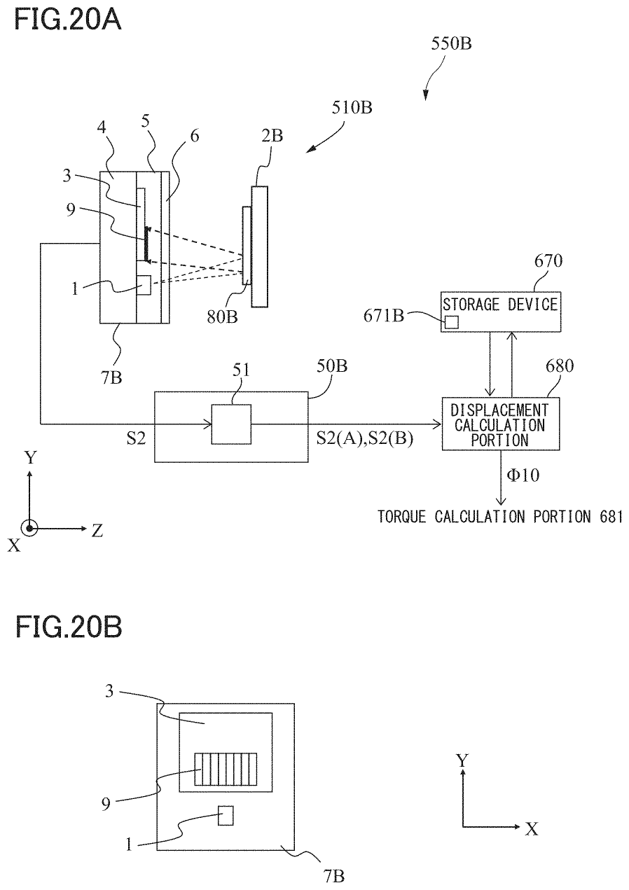

A third embodiment will be described. FIG. 20A is a schematic view of an encoder device 550B serving as an example of a displacement detection device according to the third embodiment. To be noted, in the third embodiment, elements substantially the same as in the first embodiment will be denoted by the same reference signs and description thereof will be omitted. The encoder device 550B includes an encoder 510B, a signal processing circuit 50B, and the displacement calculation portion 680 and the storage device 670 similarly to the first embodiment.

In the third embodiment, the encoder 510B illustrated in FIG. 20A is used instead of the encoder 510 in the torque sensor 500 illustrated in FIG. 4 in the robot system 100 illustrated in FIG. 1. Description will be given below with reference to also drawings described in the first embodiment.

The encoder 510B may be a linear encoder or a rotary encoder, but is a linear encoder also in the third embodiment similarly to the first embodiment. In addition, the encoder 510B is an optical encoder of a light interference type, and is an incremental encoder. In addition, although the encoder 510B is of a reflection type in the third embodiment, the encoder 510B may be of a transmission type.

The encoder 510B includes a scale 2B, and a sensor head 7B disposed at a position to oppose the scale 2B in the Z direction. The scale 2B includes a pattern portion 80B. FIG. 20B is a plan view of the sensor head 7B according to the third embodiment.

The sensor head 7B reads the pattern portion 80B of the scale 2B and outputs the detection signal S2 to the signal processing circuit 50B. The sensor head 7B includes a light source 1 constituted by an LED serving as an example of a light emitting unit, and one light receiving unit 3. The light receiving unit 3 has substantially the same configuration as the light receiving unit 3₂ described in the first embodiment. That is, in the third embodiment, the size of the sensor head 7B is reduced by omitting the light receiving unit 3₁.

The light receiving unit 3 is disposed at a distance from the light source 1 in the Y direction. The light receiving unit 3 includes the light receiving element array 9. The light source 1 and the light receiving unit 3 are mounted on the printed wiring board 4, and sealed by the transparent resin 5 that transmits light. The transparent glass 6 that transmits light is disposed on the surface of the resin 5. According to this configuration, the light source 1 and the light receiving unit 3 are protected by the resin 5 and the glass 6.

The signal processing circuit 50B is constituted by, for example, a semiconductor element constituted by an IC chip. The signal processing circuit 50B is mounted on, for example, the surface of the printed wiring board 4. To be noted, the position of the signal processing circuit 50B is not limited to this, and the signal processing circuit 50B may be disposed at a position different from a position on the printed wiring board 4. In FIG. 20A, the signal processing circuit 50B is disposed at a position different from a position on the printed wiring board 4 for the sake of convenience of description. The signal processing circuit 50B includes the circuit portion 51 that obtains the detection signal S2 from the light receiving element array 9 and processes the obtained signal. The circuit configuration of the circuit portion 51 is substantially the same as the circuit portion 51₂ described in the first embodiment, that is, substantially the same as the circuit portion 51₁.

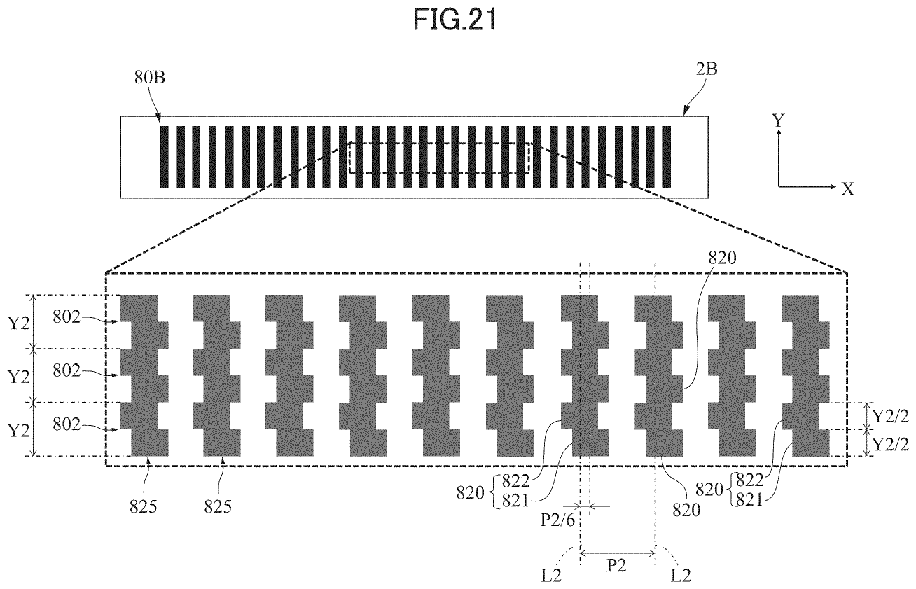

FIG. 21 is an explanatory diagram of the scale 2B according to the third embodiment. FIG. 21 illustrates the entirety of the scale 2B, and an enlarged view of part of the scale 2B. The scale 2B includes a substrate such as glass. The pattern portion 80B is formed by patterning a chromium film on the base material. To be noted, the substrate of the scale 2B may be resin such as polycarbonate or metal such as stainless steel. In addition, it suffices as long as the pattern portion 80B functions as a reflection film, and the pattern portion 80B may be formed from, for example, aluminum.

The pattern of the pattern portion 80B is configured in a similar manner to the scale track 8₂ described in the first embodiment, and the scale track 8₁ described in the first embodiment is omitted. The pattern of the pattern portion 80B is read by the light receiving element array 9. The pattern portion 80B includes a plurality of pattern rows 802 as at least one pattern row. That is, the pattern portion 80B includes the plurality of pattern rows 802 configured in a similar manner to the first embodiment, and does not include the pattern row 801 described in the first embodiment.

The pattern rows 802 each include a plurality of pattern elements 820 periodically arranged in the X direction. The plurality of pattern elements 820 are arranged at intervals in the X direction at the predetermined pitch P2 serving as a modulation period. The plurality of pattern elements 820 each have a shape asymmetrical with respect to the axis L2 extending in the Y direction.

The plurality of pattern rows 802 are continuously arranged in the Y direction. The length of each of the pattern rows 802 in the Y direction will be denoted by Y2. A plurality of pattern elements 820 of one row continuous in the Y direction constitute a pattern element group 825. In the pattern element group 825, the plurality of pattern elements 820 of the same shape are arranged in the Y direction at a period of the length Y2. In the third embodiment, a plurality of pattern element groups 825 are arranged at equal intervals at the pitch P2 in the X direction.

In each pattern row 802, the plurality of pattern elements 820 arranged at intervals in the X direction each include a rectangular portion 821 serving as a first portion and a rectangular portion 822 serving as a second portion disposed at a position displaced from the portion 821 in the X direction. The amount of displacement of the portion 822 in the X direction with respect to the portion 821 is preferably ⅙ of the pitch P2 between two adjacent pattern elements 820 among the plurality of pattern elements 820. In addition, the length of the portion 821 in the Y direction is preferably equal to the length of the portion 822 in the Y direction, that is, the length of each of the portions 821 and 822 in the Y direction is preferably Y2/2. To be noted, the pattern elements 820 are each preferably asymmetrical with respect to the axis L2, and may have, for example, a wavy shape like the pattern elements 820 of the modification example illustrated in FIG. 15.

The pattern of the pattern rows 802 is a pattern detected as displacement in the X direction by the sensor head 7B when the sensor head 7B and the scale 2B are relatively displaced from each other in the X direction. Further, the pattern of the pattern rows 802 is a pattern detected as displacement in the X direction by the sensor head 7B when the sensor head 7B and the scale 2B are relatively displaced from each other in the Y direction.

In the third embodiment, the displacement calculation portion 680 obtains the phase D10 for obtaining the torque value τ by the torque calculation portion 681 by using the sine wave signals S2(A) and S2(B) that are phase information based on the detection signal S2 from the sensor head 7B.

Hereinafter, since the control method for the robot 200 illustrated in FIG. 1 in the third embodiment is substantially the same as the flowchart of the control method illustrated in FIG. 11A described in the first embodiment, description thereof will be omitted. In the third embodiment, the flowchart illustrated in FIG. 11A illustrates an operation mode for causing the robot 200 to actually perform operations for manufacturing a product.

The torque detection method of the torque sensor in the third embodiment is different from the first embodiment. The robot 200 is an industrial robot. The robot 200 is used for successively manufacturing the same product, and repeats the same operation for this. Therefore, in the third embodiment, a correction value is measured and stored in the storage device 670 in advance. This storage operation is performed in a test run mode. Then, during an actual operation of the robot 200, that is, in the operation mode, the detection result of the encoder device 550B included in the torque sensor is corrected by using the correction value. Selection of the operation mode serving as a first mode and the test run mode serving as a second mode is performed by, for example, an operator operating the teaching pendant 400 illustrated in FIG. 1. The robot control device 300 executes the mode selected by the operator.

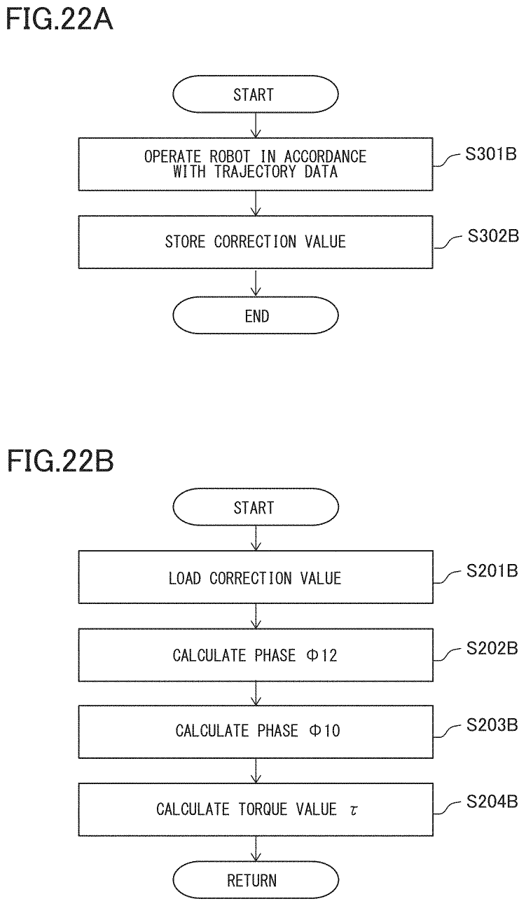

FIG. 22A is a flowchart illustrating pre-processing of the robot system according to the third embodiment. That is, the flowchart illustrated in FIG. 22A illustrates the test run mode. In step S301B, the robot control device 300 operates the robot 200 with no load in accordance with the trajectory data used in the operation mode. At this time, the CPU 651 illustrated in FIG. 5A corresponding to each of the joints J1 to J3 obtains the correction value in association with the trajectory data. In step S302B, the CPU 651 stores the correction value associated with the trajectory data in the storage device 670 illustrated in FIG. 20A as table data 671B. In this manner, the profile of the error appearing in the detection results due to the elliptical deformation of the reduction gear 143 is measured in advance as a correction value.

Here, the correction value will be described in detail. Operating the robot 200 with no load means rotating the wave generator 151 of the reduction gear 143 of each of the joints J1 to J3 in a state in which the robot 200 does not collide with a person or an object. In other words, the phrase means that the robot 200 does not touch a person or an object and no collision of objects during assembly of a product occurs, and thus no torque is generated thereby. Generally, when operating a robot, a load is generated due to the gravity of the earth and the operation of the robot even when the robot does not collide with a person or an object. Therefore, even if collision with a person or an object does not occur, the torque sensor included in each joint of the robot detects a torque depending on the orientation and operation of the robot. Therefore, a correction value needs to be obtained by obtaining the trajectory data in accordance with the orientation and operation of the robot. The trajectory data to be obtained is a profile of the rotation angle of the rotation of the wave generator 151. That is, the CPU 651 obtains the correction value in accordance with the rotation angle of the wave generator 151 as trajectory data. In addition, this correction value corresponds to the phase Φ10′+Φ10″ expressed by the formula (6) in the case of operating the robot 200 with no load. That is, by operating the robot 200 with no load, a profile corresponding to the error of the phase Φ12 is obtained as the correction value. By calculating the correction value in accordance with the orientation and operation of the robot in this manner, for example, the contact force of the robot contacting a person or an object can be accurately detected when the robot system of the present embodiment is applied to a human-cooperative robot.

The control method for the robot 200 in a manufacture process is the same as that described in the first embodiment with reference to the flowchart illustrated in FIG. 11A, and thus the description thereof will be omitted. The torque value τ obtained by the robot control device 300 in step S102 of FIG. 11A is detected as follows. FIG. 22B is a flowchart illustrating an example of a torque detection method according to the third embodiment. Here, steps S201B to S203B illustrated in FIG. 22B are arithmetic processing by the displacement calculation portion 680, and step S204B is arithmetic processing by the torque calculation portion 681.

In step S201B, the displacement calculation portion 680 loads the correction value from the table data 671B.

Next, in step S202B, the displacement calculation portion 680 detects, from the pattern rows 802, the phase Φ12 that is a displacement amount in the X direction. That is, the displacement calculation portion 680 obtains, as the phase Φ12, the displacement amount of the scale 2B in the X direction relative to the sensor head 7B by using the sine wave signals S2(A) and S2(B) from the circuit portion 51. The phase Φ12 is obtained by the formula (5) of the first embodiment described above. The phase Φ12 satisfies the formula (6) of the first embodiment described above. The correction value loaded in step S201B corresponds to the error Φ10′+Φ10″ in the formula (6).

Therefore, in step S203B, the displacement calculation portion 680 obtains the phase Φ10 by correcting the phase Φ12 by using the correction value, that is, by subtracting the correction value from the phase Φ12.

The processing of step S204B is substantially the same as the processing of step S205 described in the first embodiment. That is, in step S204B, the torque calculation portion 681 obtains the torque value τ on the basis of the four phases Φ10 respectively obtained for the four encoders 510B.

As described above, according to the third embodiment, the torque value τ can be obtained with high precision. That is, the detection precision of the torque value τ is improved. Since the torque value τ can be obtained with high precision, the operation precision of the robot 200 can be improved. In addition, the size of the encoder 510B can be reduced, and thus the size of the torque sensor 500 and the size of the robot 200 can be also reduced.

To be noted, the present invention is not limited to the embodiments described above, and can be modified in many ways within the technical concept of the present invention. In addition, the effects described in the embodiments are merely enumeration of the most preferable effects that can be obtained by the present invention, and the effects of the present invention are not limited to those described in the embodiments.

Although the case where the robot arm 201 is a vertically articulated robot arm has been described in the embodiments described above, the configuration is not limited to this. For example, various robot arms can be the robot arm 201, such as horizontally articulated robot arms, parallel link robot arms, and orthogonal robots.

In addition, although a case where the torque sensor is disposed on the output side of the reduction gear has been described in the embodiments described above, the configuration is not limited to this, and the torque sensor may be disposed on the input side of the reduction gear. It suffices as long as the torque sensor is disposed at a position where the elliptical deformation force of the reduction gear is transmitted to the torque sensor in the joint or the driving device.

In addition, although a case where the encoder is an incremental encoder has been described in the embodiments described above, the configuration is not limited to this, and the encoder may be an absolute encoder.

In addition, although a case where the torque sensor includes four encoders have been described in the embodiments described above, the configuration is not limited to this. For example, a case where the torque sensor includes only one encoder is also possible. In this case, the calculation for averaging the phase Φ10 is not needed when calculating the torque value τ. Of course, it is preferable that the torque sensor includes four encoders, and the error of the detected phase can be reduced by averaging four phases Φ10 detected by the four encoders.

In addition, although a case where the reduction gear is a strain wave reduction gear and the flex spline of the strain wave reduction gear has a cup shape has been described in the embodiments described above, the configuration is not limited to this. The flex spline may have a shape different from the cup shape, for example, a top hat shape.

In addition, although a case where the one CPU 651 realizes the functions of the plurality of displacement calculation portions 680 and the torque calculation portion 681 has been described, the configuration is not limited to this, and these functions may be realized by a plurality of CPUs.

As described above, the detection precision can be improved according to the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-32211, filed Mar. 2, 2021, which is hereby incorporated by reference herein in its entirety.

What is claimed is:

1. A robot system comprising:
a robot including, in a joint thereof, a reduction gear and at least one encoder; and
a processing portion configured to obtain a torque value by using phase information based on a detection signal of the encoder,
wherein the encoder includes
a scale including a pattern portion, and
a head disposed to oppose the scale and configured to read the pattern portion of the scale and output the detection signal, and
wherein the processing portion is configured to
obtain, on a basis of the phase information, a first displacement amount of the scale in a first direction and a second displacement amount of the scale in a second direction, the first direction being a relative direction with respect to the head, the second direction being a relative direction with respect to the head and intersecting with the first direction, and
obtain the torque value on a basis of the first displacement amount and the second displacement amount.

2. The robot system according to claim 1,
wherein the pattern portion includes
at least one first pattern row including a plurality of first pattern elements periodically arranged in the first direction, the plurality of first pattern elements each having a shape symmetrical with respect to a first axis extending in the second direction, and
at least one second pattern row including a plurality of second pattern elements periodically arranged in the first direction, the plurality of second pattern elements each having a shape asymmetrical with respect to a second axis extending in the second direction.

3. The robot system according to claim 2, wherein the at least one second pattern row includes a plurality of second pattern rows continuously arranged in the second direction.

4. The robot system according to claim 2,
wherein the at least one first pattern row includes a plurality of first pattern rows,
wherein the at least one second pattern row includes a plurality of second pattern rows, and
wherein the plurality of first pattern rows and the plurality of second pattern rows are alternately arranged in the second direction.

5. The robot system according to claim 2,
wherein the phase information includes first information and second information, the first information being obtained by the head reading the at least one first pattern row, the second information being obtained by the head reading the at least one second pattern row, and
wherein the processing portion is configured to
obtain the first displacement amount from the first information, and
obtain the second displacement amount from the second information and the first displacement amount.

6. The robot system according to claim 1, wherein the reduction gear is a strain wave reduction gear.

7. The robot system according to claim 6, wherein the processing portion is configured to obtain the torque value further on a basis of a rotation direction of the joint.

8. The robot system according to claim 1,
wherein the at least one encoder includes a plurality of encoders, and
wherein the processing portion is configured to obtain the torque value by using the phase information based on the detection signal from each of the plurality of encoders.

9. A robot system comprising:
a robot including, in a joint thereof, a reduction gear and at least one encoder;
a processing portion configured to obtain a torque value by using phase information based on a detection signal of the encoder; and
a storage portion configured to store a correction value associated with trajectory data of the robot,
wherein the encoder includes
a scale including a pattern portion, and
a head disposed to oppose the scale and configured to read the pattern portion of the scale and output the detection signal, and
wherein the processing portion is configured to
obtain, on a basis of the phase information obtained while the robot is operating in accordance with the trajectory data, a first displacement amount of the scale in a first direction that is a relative direction with respect to the head, and
obtain the torque value on a basis of displacement information obtained by correcting the first displacement amount by using the correction value corresponding to the trajectory data.

10. The robot system according to claim 9,
wherein the pattern portion includes at least one pattern row including a plurality of pattern elements periodically arranged in the first direction, and
wherein the plurality of pattern elements each have a shape asymmetrical with respect to an axis extending in a second direction intersecting with the first direction.

11. The robot system according to claim 10, wherein the at least one pattern row includes a plurality of pattern rows continuously arranged in the second direction.

12. The robot system according to claim 11, wherein the reduction gear is a strain wave reduction gear.

13. The robot system according to claim 12, wherein the processing portion is configured to obtain the torque value further on a basis of a rotation direction of the joint.

14. The robot system according to claim 9,
wherein the at least one encoder includes a plurality of encoders, and
wherein the processing portion is configured to obtain the torque value by using the phase information based on the detection signal from each of the plurality of encoders.

15. A method for manufacturing a product by using the robot system according to claim 1.

16. A method for manufacturing a product by using the robot system according to claim 9.
